(19) United States
(12) Patent Application Publication
(10) Pub. No.: US 2016/0277838 A1
(43) Pub. Date: Sep. 22, 2016

(54) MULTI-LAYERED MEMS SPEAKER

(71) Applicant: DSP Group LTD., Herzeliya (IL)

(72) Inventors: Haim Kupershmidt, Or Yehuda (IL); Moti Margalit, Zichron Yaaqov (IL); Adi Baram, Yokneam Ilit (IL)

(21) Appl. No.: 15/072,379

(22) Filed: Mar. 17, 2016

Related U.S. Application Data
(60) Provisional application No. 62/134,076, filed on Mar. 17, 2015.

(51) Int. Cl. H04R 7/16

(52) U.S. Cl. CPC H04R 7/16; H04R 2201/003

(57) ABSTRACT

A micro-electromechanical system (MEMS) device that may include a substrate, support structures and functional elements; wherein the functional elements are included in a plurality of functional layers, the plurality of functional layers are spaced apart from each other; wherein the support structures are conductive and are configured to provide structural support to the plurality of functional layers; wherein each functional element is electrically coupled to at least one of the support structures; and wherein the support structures are spaced apart from each other.

### RELATED APPLICATIONS

This application claims priority from U.S. Provisional Patent Application Ser. No. 62/134,076 filing date Mar. 17, 2015 which is being incorporated herein by reference.

### BACKGROUND OF THE INVENTION

U.S. Pat. No. 8,861,752 discloses a speaker array. The speaker array may include a first speaker and a second speaker. The first speaker includes a first membrane and a first shutter. The second speaker includes a second membrane and a second shutter. The first membrane may be configured to oscillate in a first directional path and at a first frequency effective to generate a first ultrasonic acoustic signal. The first shutter may be positioned above the first membrane and configured to modulate the first ultrasonic acoustic signal such that a first audio signal is generated. The second membrane may be configured to oscillate in the first directional path and at a second frequency effective to generate a second ultrasonic acoustic signal. The second shutter may be positioned above the second membrane and configured to modulate the second ultrasonic acoustic signal such that a second audio signal is generated.

FIG. 1 is a cross sectional view of a prior art speaker 100. Speaker device 100 includes shutter 101, blind 103, membrane 105, substrate 107, controller 109, and spacers 111. Speaker device 100 may be a micro electro mechanical system (MEMS) and pico-sized. Therefore, speaker device 100 may be suitable for mobile devices because of its compact size. Substrate 107 can be a silicon substrate of a micro electro mechanical system. Spacers 111 can be configured to separate shutter 101, blind 103, membrane 105, and substrate 107.

Membrane 105 can be electrically coupled to controller 109. Controller 109 can be configured to apply a first signal 115 to membrane 105. In response to first signal 115, membrane 105 can oscillate along a directional path 190 effective to generate ultrasonic acoustic wave 117. Ultrasonic acoustic wave 117 may propagate along the directional path 190 from membrane 105 towards blind 103 and shutter 101.

In some examples, first alternating signal 115 may be a voltage or a current that alternates according to a first frequency. In some other examples, first alternating signal 115 may be some other variety of periodically changing signal such as a current or voltage that may be sinusoidal, pulsed, ramped, triangular, linearly changing, non-linearly changing, or some combination thereof. The oscillation frequency of membrane 105 can be substantially proportional to the frequency of first alternating signal 115. Therefore, by applying different alternating signals 115, controller 109 can control the oscillation frequency of membrane 105.

Blind 103 can be positioned above membrane 105 and below shutter 101. Blind 103 can include a first set of rectangular openings (not shown). Ultrasonic acoustic wave 117 passes through the openings of blind 103 through to shutter 101.

Shutter 101 is electrically coupled to controller 109. Controller 109 can be configured to apply a second signal 113 to shutter 101. In response to second signal 113, shutter 101 can moves along a directional path 192 between a first position and a second position. Shutter 101 includes a second set of openings (not shown). The relationship and orientation of the first set of openings relative to the second set of openings will be further described below.

FIG. 2 is a top view of an illustrative embodiment of a prior art speaker array 200. Speaker array 200 can include a first speaker device 210 and a second speaker device 220. First speaker device 210 can include a first shutter 211 and a first membrane 213. First shutter 211 and first membrane 213 are both electrically coupled to controller 230. Controller 230 can be configured to apply a first signal to first shutter 211 and a second signal to first membrane 213. As set forth above, the moving frequency of first shutter 211 and the oscillation frequency of first membrane 213 can be associated with the first signal and the second signal, respectively. A first audio signal can be generated based on the movement of the first shutter 211 and the oscillating membrane 213.

Second speaker device 220 can include a second shutter 221 and a second membrane 223. Second shutter 221 and second membrane 223 are both electrically coupled to controller 230. Controller 230 can be configured to apply a third signal to second shutter 221 and a fourth signal to second membrane 223. As set forth above, the moving frequency of second shutter 221 and the oscillation frequency of second membrane 223 are associated with the third signal and the fourth signal, respectively. A second audio signal can be generated based on the movement of the second shutter 221 and the oscillating membrane 223.

When the moving frequencies of first shutter 211 and second shutter 221, and the oscillation frequencies of first membrane 213 and second membrane 223 are substantially the same, the first audio signal can be generated by first speaker device 210 and the second audio signal can be generated by second speaker device 220 have substantially the same frequency. When the moving frequencies of first shutter 211 and second shutter 221 are different, or the oscillation frequencies of first membrane 213 and second membrane 223 are different, the first audio signal generated by first speaker 210 and the second audio signal generated by second speaker 220 have substantially different frequencies. Generating different audio signals from various elements in the speaker array can be used for generating psychoacoustic effects creating the illusion of novel sound location or unique temporal effects in the acoustic signal.

There is a growing need to provide efficient manufacturing process for manufacturing such a speaker.

### SUMMARY

According to an embodiment of the invention there may be provided a MEMS device that may include a substrate, support structures and functional elements; wherein the functional elements may be included in a plurality of functional layers, the plurality of functional layers may be spaced apart from each other; wherein the support structures may be conductive and may be configured to provide structural support to the plurality of functional layers; wherein each functional element may be electrically coupled to at least one of the support structures; and wherein the support structures may be spaced apart from each other.

A given support structure may include first portions that may be included within the plurality of functional layers and second portions which may be positioned between the plurality of functional layers.

The first portions and the second portions may be vertically aligned.

The first portions and the second portions may be vertically misaligned.

The support structures may include a conductive envelope and one or more core segments that may be at least partially insulating.

The support structures may include one or more core segments that may be surrounded by other segments; wherein the other segments may include a conductive envelope; wherein for a given etch process the one or more core segments exhibit an etch rate that exceeds an etch rate of the other segments.

The one or more core segments may be made of a material selected out of Tetraethyl orthosilicate, Silicon Oxide, and undoped Silica glass (USG).

A number of functional layers of the plurality of functional layers may exceed three.

The MEMS functional elements may include a membrane, a blind and a shutter.

The membrane, the blind and the shutter belong to different functional layers of the plurality of functional layers.

The support structures may be arranged in groups.

A given group of support structures may be electrically coupled to a given MEMS functional element; and wherein the given group of support structures surrounds the given MEMS functional element.

At least two groups of support structures share at least one support structure.

At least two adjacent groups of support structures do not share any support structure.

All support structures of a given group of support structures have a same size and shape.

Two or more support structures of a given group of support structures differ from each other by shape.

Two or more support structures of a given group of support structures differ from each other by size.

There may be at least three support structures per group.

The support structures may be shaped as pillars.

The MEMS device further may include one or more perforated dielectric functional layers.

A first functional element may belong to a first functional layer and wherein a second functional element may belong to a second functional layer.

There may be an air gap between the support structures.

A first functional element that belongs to a first functional layer may be electrically coupled to a first set of support structures; wherein a second functional element that belongs to a second functional layer may be coupled to a second set of support structures; wherein the first set of support structures differs from the second set of support structures.

Some functional elements that belong to some functional layers may be electrically coupled to different sets of support structures.

A certain functional layer may include multiple functional elements.

All of the multiple functional elements of the certain functional layer are substantially identical to each other.

At least some functional elements of the multiple functional elements of the certain functional layer differ from each other.

All of the multiple functional elements of the certain functional layer may be electrically coupled to each other.

Some of the multiple functional elements of the certain functional layer may be not electrically coupled to each other.

A functional element that belongs to a certain functional layer may be electrically coupled to a set of the support structures; wherein there may be an air gap between the functional element and support structures that may be not included in the set of support structures.

Each functional layer of at least two functional layers may include multiple functional elements.

According to an embodiment of the invention there may be provided a method for manufacturing a micro-electromechanical system (MEMS) device. The method may include performing a plurality of manufacturing iterations to provide an alternating sequence of functional layers and intermediate layers; wherein the functional layers comprise functional elements and portions of support structures; wherein each functional element is electrically coupled to at least one of the portions of the support structure; wherein the intermediate layers comprise other portions of the support structures and a filling material; and removing the filling material to provide functional layers that are spaced apart from each other and are supported by the support structures; wherein the support structures are conductive and are spaced apart from each other. The filling material may include, for example, Silicon Oxide.

At least one manufacturing iteration may include surrounding a core made of a filling material with a material that withstands the removing of the filling material.

According to an embodiment of the invention there may be provided a method for manufacturing a micro-electromechanical system (MEMS) device. The method may include generating multiple sacrificial layer patterns and multiple conductive layer patterns by repeating the steps of depositing a sacrificial layer; patterning the sacrificial layer to provide a sacrificial layer pattern; depositing a conductive layer; patterning the conductive layer thereby forming a conductive layer pattern. The method may proceed by depositing a top sacrificial layer; patterning the top sacrificial layer to provide a top sacrificial layer pattern; depositing a top conductive layer; depositing a metal layer; patterning the metal layer to provide a metal layer pattern; patterning the top conductive layer thereby forming the top conductive layer pattern; and removing, by applying an etch process, each sacrificial layer pattern that is exposed to the etch process thereby exposing support structures and functional elements that are formed by the multiple conductive layer patterns.

The generating of the multiple sacrificial layer patterns and of the multiple conductive layer patterns may be preceded by depositing a passivation layer on a substrate; and patterning the passivation layer to provide a passivation layer pattern.

The multiple conductive layer patterns may define the functional elements and/or define edges of the support structures.

The functional elements may be included in a plurality of functional layers, the plurality of functional layers may be spaced apart from each other; wherein the support structures may be conductive and may be configured to provide structural support to the plurality of functional layers; wherein each functional element is electrically coupled to at least one of the support structures; and wherein the support structures may be spaced apart from each other.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a cross sectional view of a prior art speaker;

FIG. 2 is a top view of an illustrative embodiment of a prior art speaker array;

FIG. 3 illustrates a set of support structure according to an embodiment of the invention, for a single cell in an array;

FIG. 4A illustrates a set of support structure according to an embodiment of the invention, for a single cell in an array;

FIG. 4B illustrates a set of support structure according to an embodiment of the invention, for a single cell in an array;

FIG. 5 illustrates an array of set of support structure according to an embodiment of the invention;

FIG. 6 illustrates a first layer that includes a membrane and a set of support structure according to an embodiment of the invention;

FIG. 7 illustrates a second layer that includes a blind and a set of support structure according to an embodiment of the invention;

FIG. 8 illustrates a third layer that includes a shutter and a set of support structure according to an embodiment of the invention;

FIG. 9A illustrates a mask of a first layer that includes a membrane according to an embodiment of the invention;

FIG. 9B illustrates a mask of an intermediate layer positioned between the first and second layers according to an embodiment of the invention;

FIG. 10 illustrates a mask of a second layer according to an embodiment of the invention;

FIG. 11A illustrates support elements and a mask of an intermediate layer according to an embodiment of the invention;

FIG. 11B illustrates a mask of an intermediate layer according to an embodiment of the invention;

FIG. 12 illustrates a mask of a third layer according to an embodiment of the invention;

FIG. 13 illustrates a top layer according to an embodiment of the invention;

FIG. 14 illustrates a method according to an embodiment of the invention;

FIG. 15 illustrates a method according to an embodiment of the invention;

FIGS. 16-30 include top views and cross sectional views of a MEMS device during different manufacturing steps according to an embodiment of the invention;

FIGS. 31-36 illustrate various masks according to various embodiments of the invention;

FIG. 37 is a cross sectional view of a speaker according to an embodiment of the invention; and

FIGS. 38-52 illustrate various masks according to an embodiment of the invention.

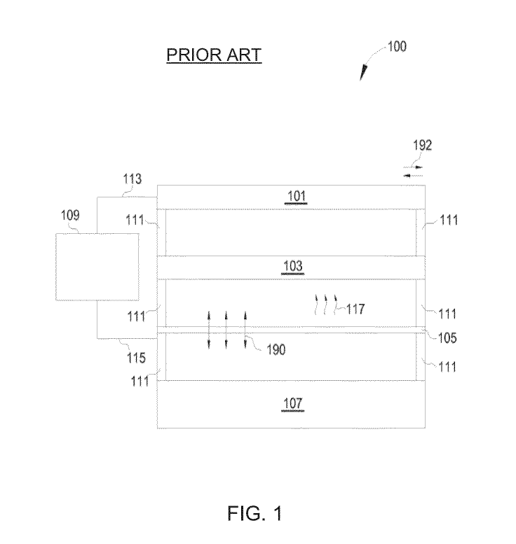

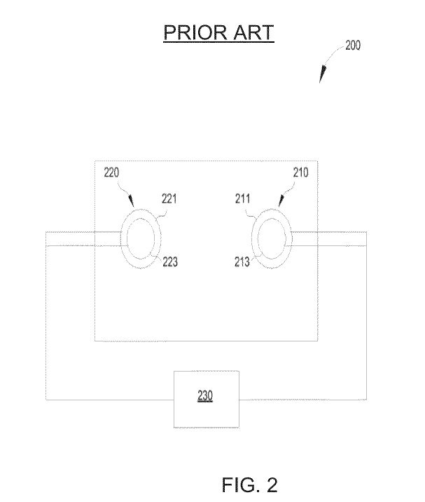

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

The term “conductive” means electrically conductive.

According to an embodiment of the invention there is provided a speaker or an array of speakers that includes multiple layers. For example the speaker may include a first layer followed by a first intermediate layer, followed by a second layer, followed by a second intermediate layer that is followed by a third layer. These layers are manufactured by a lithographic process using masks. In any of the following figures mask dark elements may represents areas that are not etched or etched, per specific mask.

According to an embodiment of the invention there are provided support structure that are electrically conductive. A support structure is deemed to be conductive even when it includes electrically insulating elements and electrically conductive elements. For example—a conductive support structure may include a conductive envelope that may surround one or more insulating elements.

Any reference to a support structure should be regarded as a reference to an electrically conductive support structure.

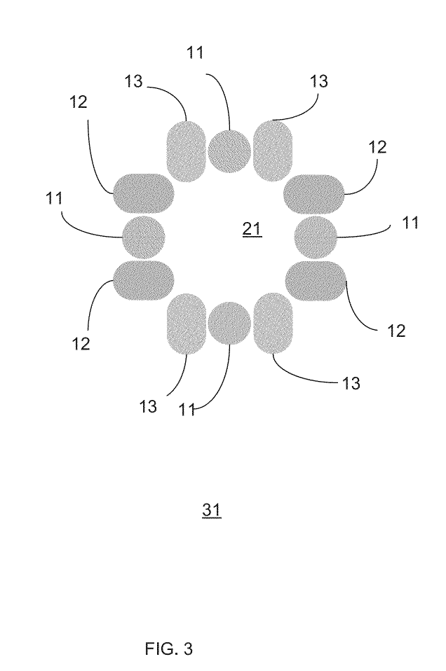

FIG. 3 illustrates a set 31 of twelve support structures—that are arranged in four triplets of support structures—each triplet includes a single support structure from a first, second and third sub-sets of support structure. For example, and going in a clockwise direction, each triplet starts by support structure 11, followed by support structure 12 and ends with support structure 13.

Set 13 includes four support structures denotes 11 (first sub-set of support structures), four support structures denoted 12 (second sub-set of support structures), and four support structures denoted 13 (third sub-set of support structures).

Support structures 11 differ by shape from support structures 12 and 13. Support structures 12 differ by orientation from support structures 13.

A set of support structures may have support structures of any shape size and orientation.

All the support structures of the set 31 are spaced apart from each other.

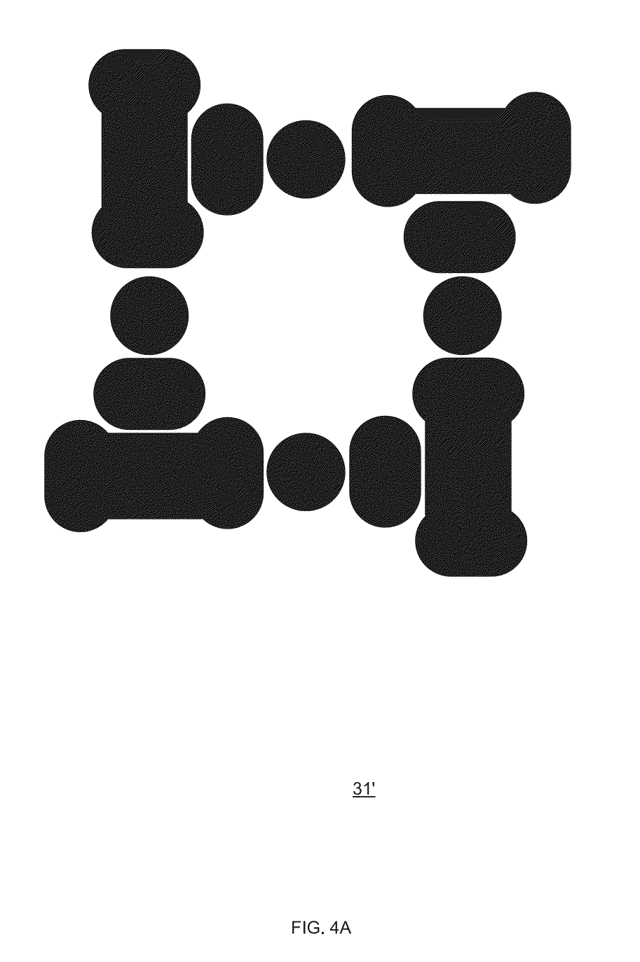

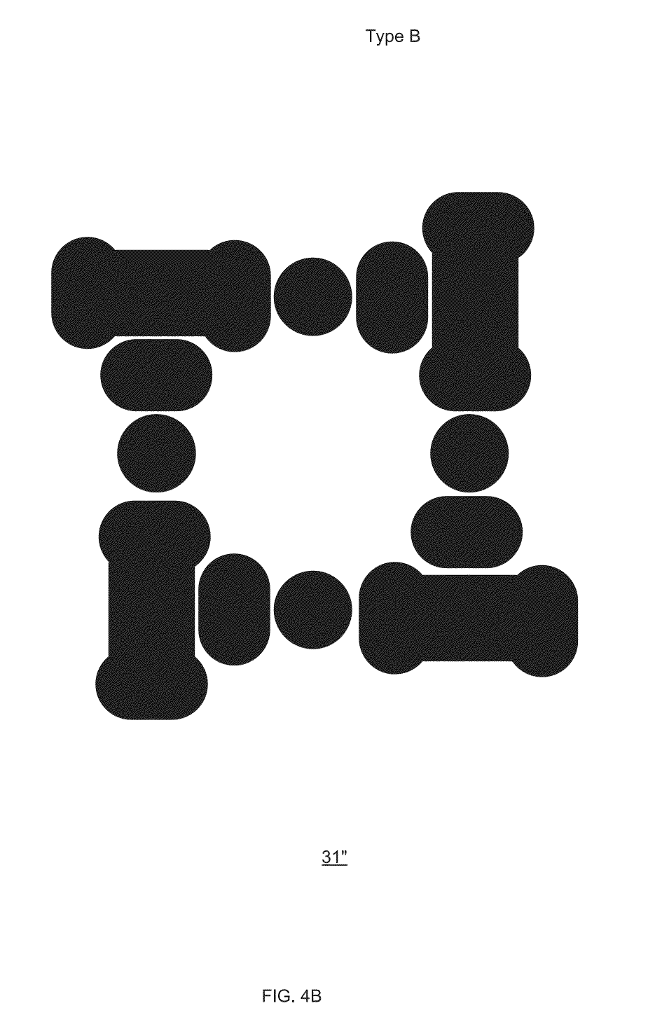

FIG. 4A illustrates a set 31′ of twelve support structures that differ by shape and size from the support structure of set 31 of FIG. 3.

FIG. 4B illustrates a set 31″ of twelve support structures that have the same shape as the support structure of set 31′ of FIG. 4A but differ by their arrangement from the support structure of set 31′ of FIG. 4A.

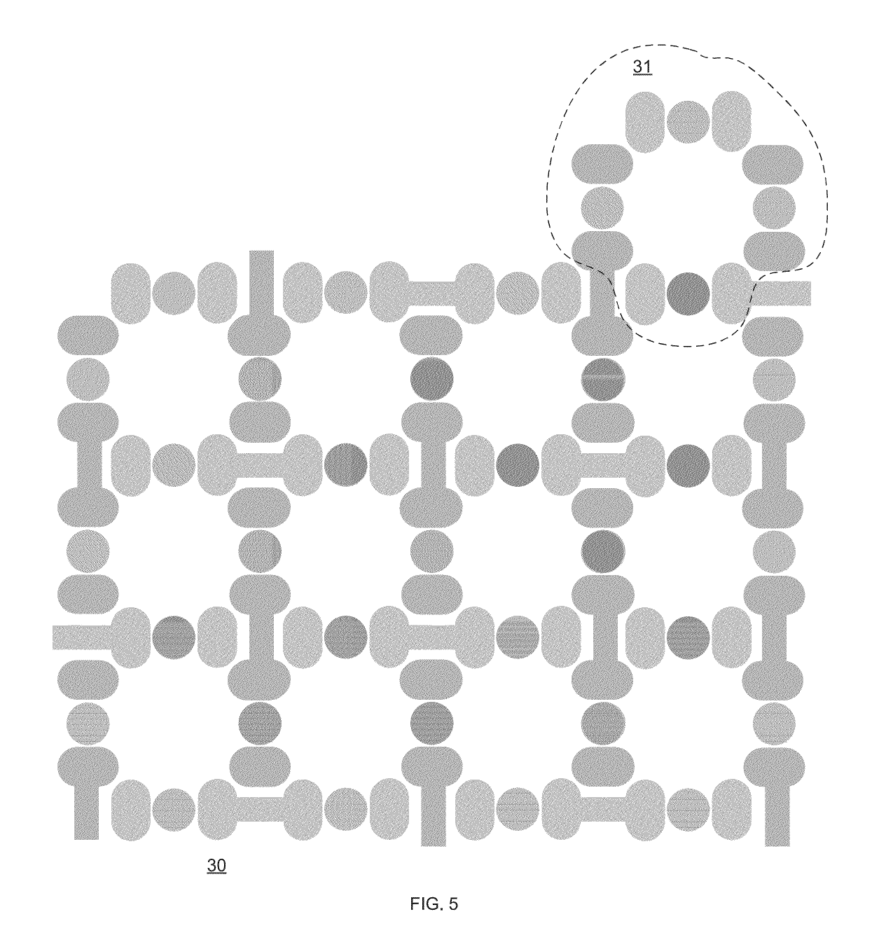

FIG. 5 illustrates an array of sets of support structure such as set 31 of FIG. 3.

The sets of the array are arranged in an orderly space-periodic form. It should be noted that the support structure of adjacent cells are reused for these cells for better spacial efficiency.

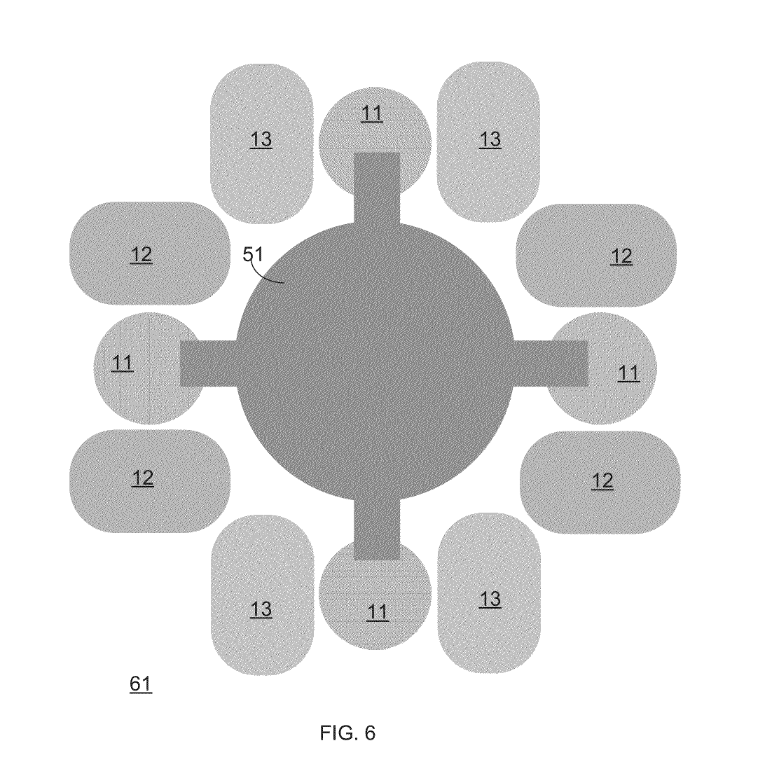

FIG. 6 illustrates a first layer 61 that includes a membrane 51 that is surrounded by a set of twelve support structures of set 31. Membrane 51 is electrically coupled to four support structures 11 (first sub-set of support structures) and is spaced apart (by an air gap) from support structures 12 and 13.

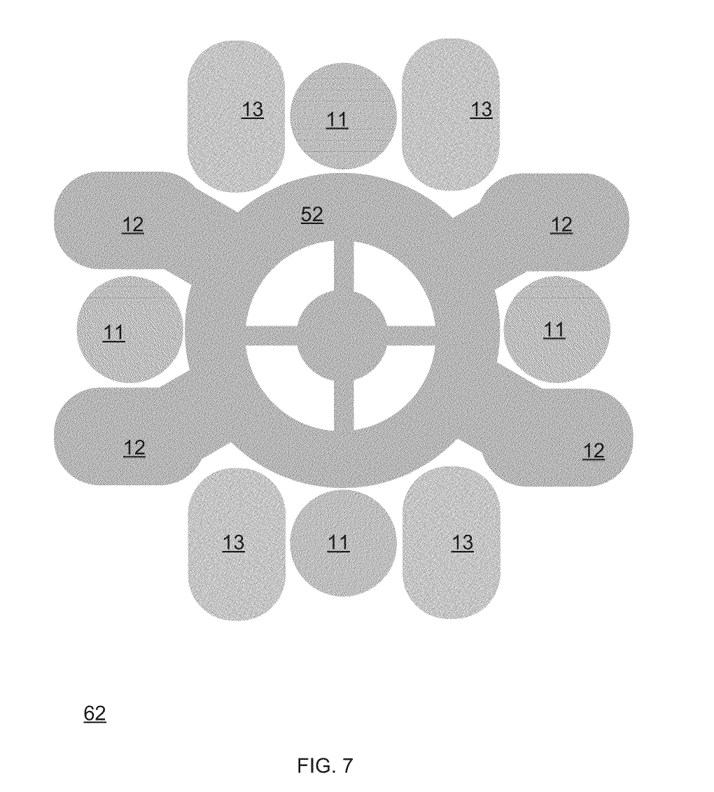

FIG. 7 illustrates a second layer 62 that includes a blind 52 and twelve support structures (such as those of set 31) according to an embodiment of the invention. Blind 52 is electrically coupled to support structures 12 (second sub-set of support structures) and is spaced apart (by an air gap) from support structures 11 and 13.

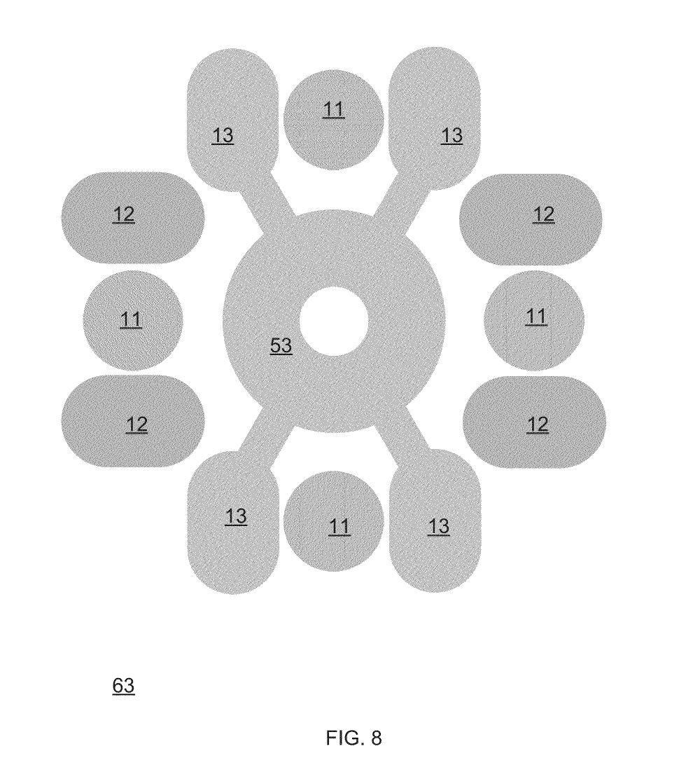

FIG. 8 illustrates a third layer 63 that includes a shutter 53 and twelve support structures (such as those of set 31) according to an embodiment of the invention.

Shutter 53 contacts a third sub-set of support structures (support structures 13) and is spaced apart (by an air gap) from support structures 11 and 12.

Each one of the first, second and third layers 61, 62 and 63 may be formed by using one or more masks. Intermediate layers may be manufactured below and/or above each one of the first, second and third layers 61, 62 and 63. These intermediate layers may be partially etched and provide at least some of the support structure.

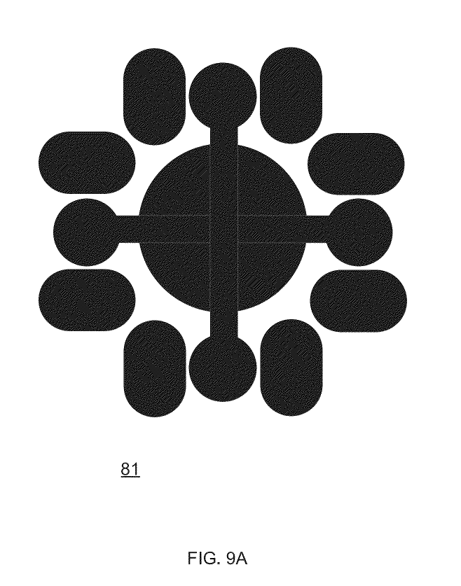

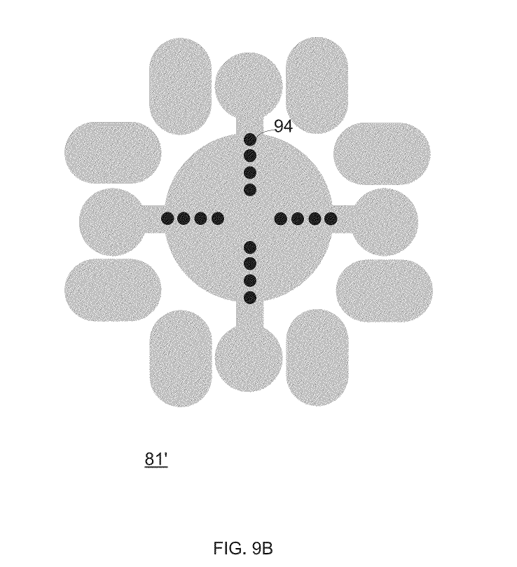

FIG. 9A illustrates a mask 81 of a first layer according to an embodiment of the invention.

FIG. 9B illustrates a mask 81′ of an intermediate layer that is positioned between the first layer and the second layer according to an embodiment of the invention. Mask 81′ may have apertures 94 above the membrane of the first layer to implement anti-stiction “dimples” on the lower membrane.

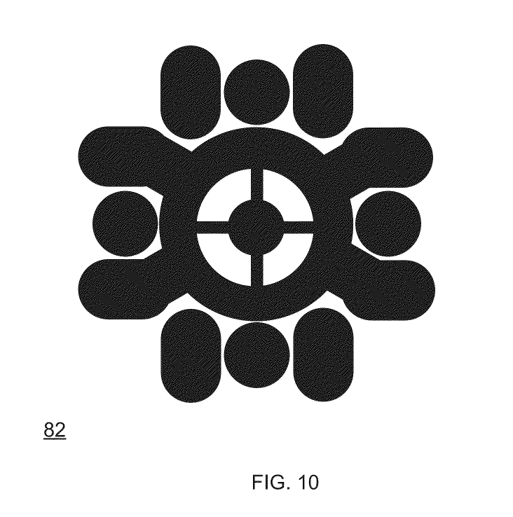

FIG. 10 illustrates a mask 82 of a second layer 82 that may include a blind according to an embodiment of the invention.

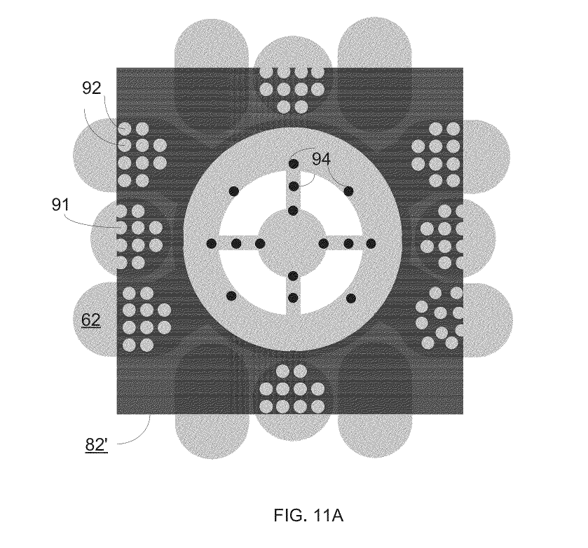

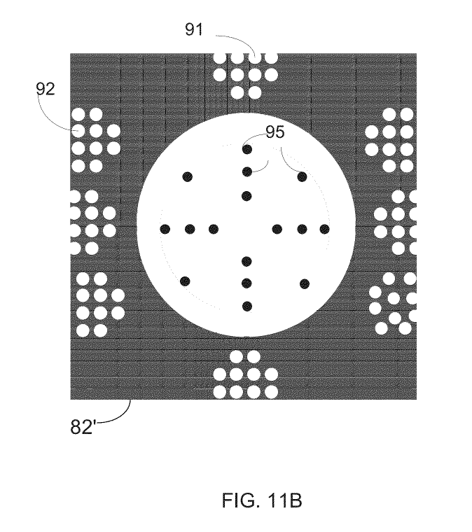

FIG. 11A illustrates support elements and a mask 82′ of an intermediate layer that is positioned between the second layer and the third layer. Mask 82′ includes (a) apertures 94 above the blind—to prevent stiction between the blind and the shutter of the third layer, (b) apertures 91 above support element 11—to be filled within conductive materials, and (c) apertures 92 above support elements 92—to be filled within conductive materials.

Mask 82′ may be used for depositing a layer to provide acoustic isolation between the membrane and the membrane vicinity (positioned below the second intermediate layer) and the shutter and the vicinity of the shutter

FIG. 11B shows the mask 82′ of FIG. 11A with apertures 95 that correspond to the locations of dimples 94 of FIG. 11A but without the supporting elements.

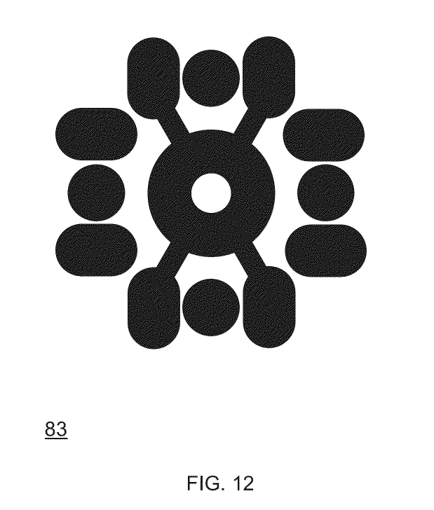

FIG. 12 illustrates a mask 83 of the third layer (Shutter layer).

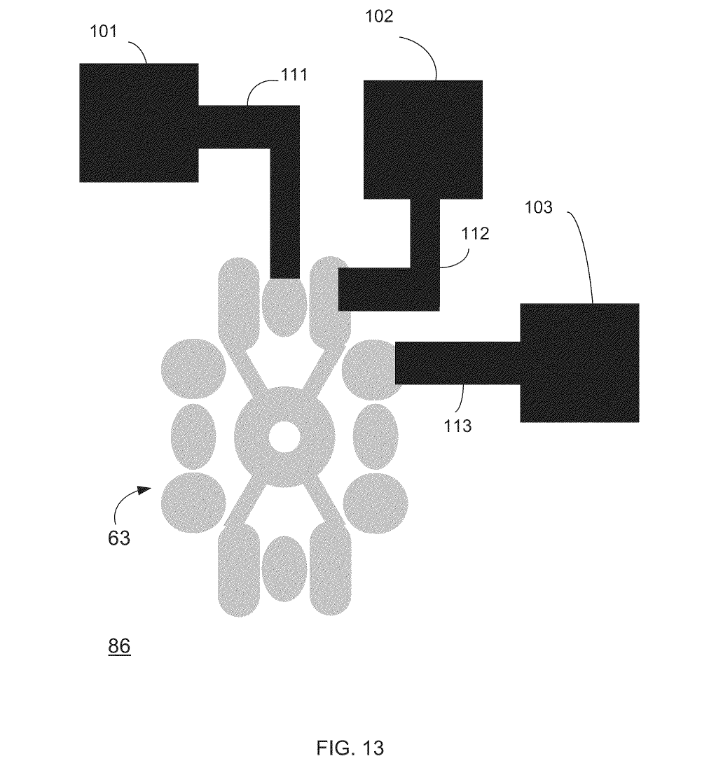

FIG. 13 illustrates a top layer 86 that is above the third layer according to an embodiment of the invention.

Top layer 86 includes bond pads 101, 102 and 103 and connections 111, 112 and 113 that are connected between the supporting structures for lower membrane (first layer), shutter (of the third layer) and the blind (second layer) respectively and the bond pads 101, 102 and 103, according to an embodiment of the invention.

In MEMS processing, free standing membranes are formed by etching a sacrificial layer from below and above the membrane. Examples of such devices include, CMUT, Gyros, accelerometers, mirrors and others. The etch is done with a HF vapor which etches isotropically. Hence any removal of material from under the membrane also removes material from the sides of the membrane.

The current application is applicable to any MEMS device, but for simplicity of explanation it is described in detail for MEMS speakers.

The fill factor (or distance between membranes) is limited because of the sideways etch of the 1st, 2nd and 3rd sacrificial layers. Hence, if the etch is not limited by some means, this distance is at least twice the maximum horizontal etch under the membrane.

To increase sound volume generation per given silicon area, or to increase silicon utilization and reduce cost there, is a need to increase the fill factor.

According to an embodiment of the invention there is provided a multi layered MEMS device that includes a top surface with electrical pads deposited on top surface (for example top layer of FIG. 13), two or more electrically conducting functional layers that may include one or more membranes, a conducting structure which spans the height of the MEMS device (such as but not limited to the sets of support structure); wherein the conducting structure is electrically connected to one electrically conducting layer, electrically isolated by mechanical separation from additional electrically conducting layer and electrically connected to at least of said electrical pads.

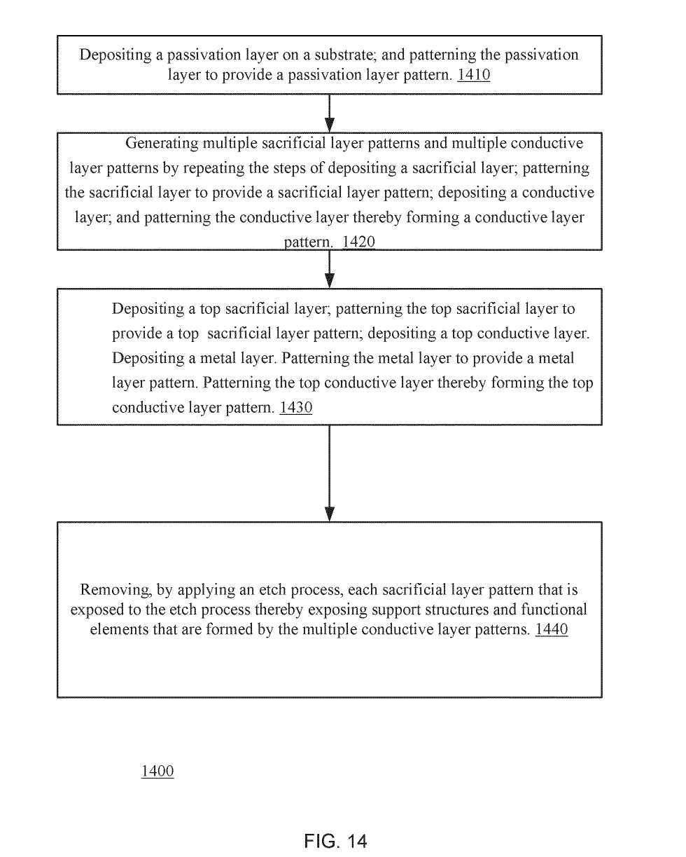

FIG. 14 illustrates method 1400 according to an embodiment of the invention.

Method 1400 may start by step 1410 of depositing a passivation layer on a substrate; and patterning the passivation layer to provide a passivation layer pattern.

Step 1410 may be followed by step 1420 of generating multiple sacrificial layer patterns and multiple conductive layer patterns by repeating (for example N−1 times) the steps of depositing a sacrificial layer, patterning the sacrificial layer to provide a sacrificial layer pattern, depositing a conductive layer and patterning the conductive layer thereby forming a conductive layer pattern.

Step 1420 may include performing multiple manufacturing iterations. Each manufacturing iterations includes depositing a sacrificial layer, patterning the sacrificial layer to provide a sacrificial layer pattern, depositing a conductive layer and patterning the conductive layer thereby forming a conductive layer pattern.

The sacrificial layer patterned during a manufacturing iteration is deposited on top of the conductive layer pattern formed during the previous manufacturing iteration.

The patterning of each sacrificial layer of step 1420 may include creating a photoresist layer pattern; developing the photoresist pattern; etching the sacrificial layer to form the sacrificial layer pattern; wherein the etching comprises removing completely all sacrificial layers parts not covered by the photoresist pattern.

Step 1420 may be followed by step 1430 of depositing a top (N'th) sacrificial layer; patterning the top sacrificial layer to provide a top sacrificial layer pattern; depositing a top (N'th) conductive layer. Depositing a metal layer. Patterning the metal layer to provide a metal layer pattern. Patterning the top conductive layer thereby forming the top conductive layer pattern.

Step 1430 may be followed by step 1440 of removing, by applying an etch process, each sacrificial layer pattern that is exposed to the etch process thereby exposing support structures and functional elements that are formed by the multiple conductive layer patterns.

The multiple conductive layer patterns may define the functional elements and/or define edges of the support structures.

Method 1400 may be used to manufacture a MEMS device that includes a substrate, support structures and functional elements; wherein the functional elements may be included in a plurality of functional layers, the plurality of functional layers may be spaced apart from each other; wherein the support structures may be conductive and may be configured to provide structural support to the plurality of functional layers; wherein each functional element may be electrically coupled to at least one of the support structures; and wherein the support structures may be spaced apart from each other.

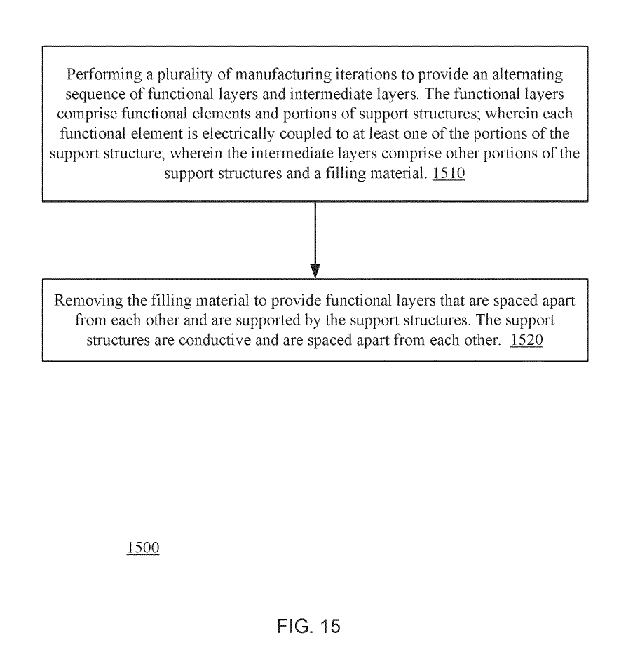

FIG. 15 illustrates method 1500 according to an embodiment of the invention.

Method 1500 may start by step 1510 of performing a plurality of manufacturing iterations to provide an alternating sequence of functional layers and intermediate layers. The functional layers comprise functional elements and portions of support structures; wherein each functional element is electrically coupled to at least one of the portions of the support structure; wherein the intermediate layers comprise other portions of the support structures and a filling material.

Step 1510 may be followed by step 1520 of removing the filling material to provide functional layers that are spaced apart from each other and are supported by the support structures. The support structures are conductive and are spaced apart from each other. The filling material may include, for example, Silicon Oxide.

Non-limiting example of step 1510 include step 1420 of method 1400.

At least one manufacturing iteration may include surrounding a core made of a filling material with a material that withstands the removing of the filling material.

FIGS. 16-30 include top views and cross sectional views of a MEMS device during different manufacturing steps according to an embodiment of the invention. Each figure includes a top view of the MEMS device and a cross sectional view of the MEMS device. The cross sectional view of the MEMS device may combine cross sections taken across one or more imaginary lines that are illustrated in top view of the MEMS device.

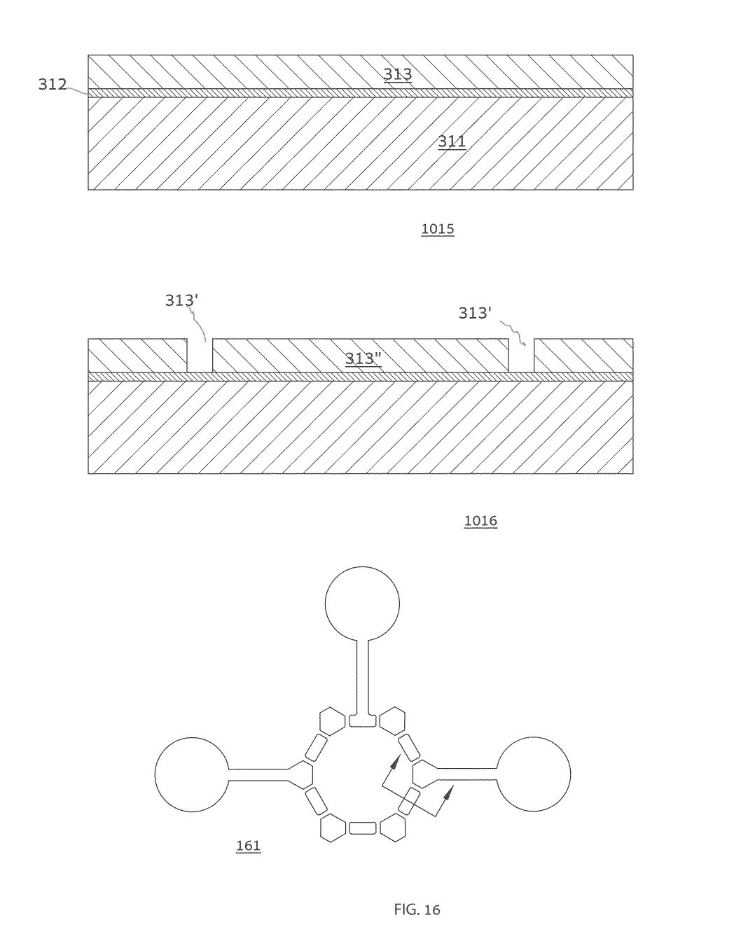

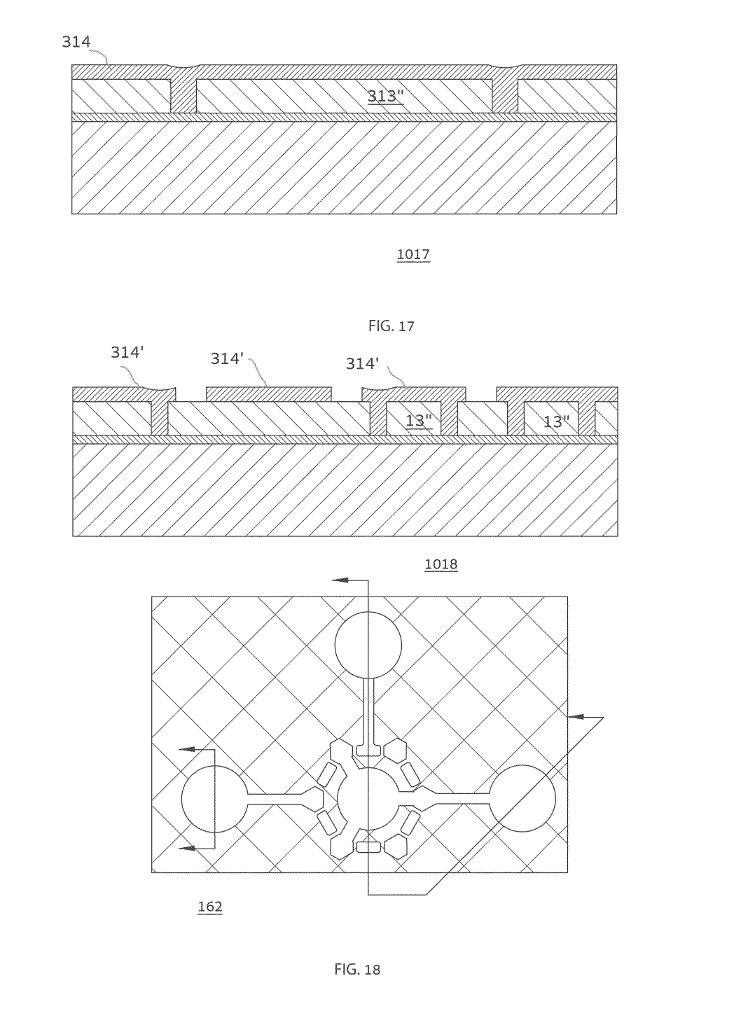

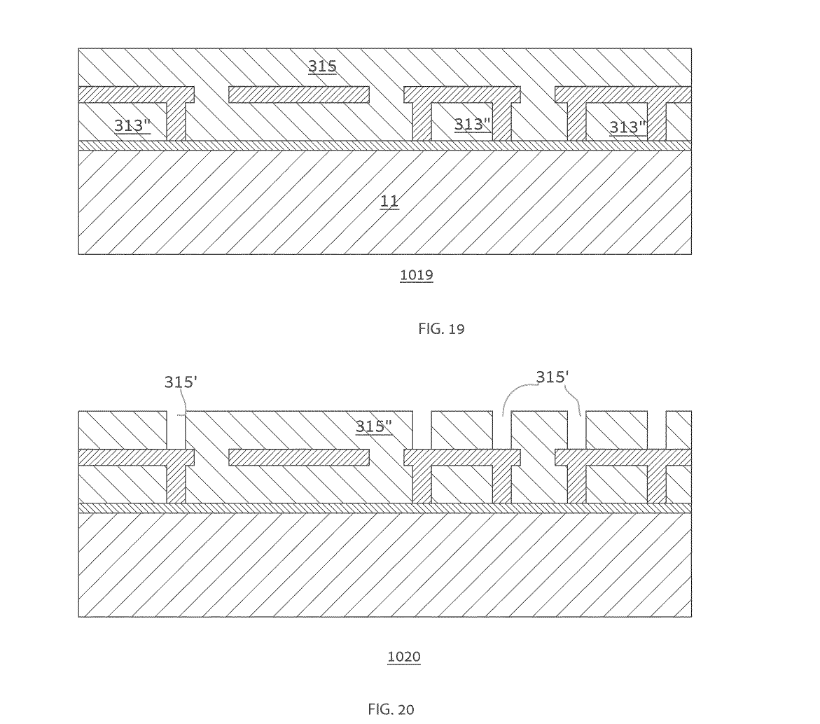

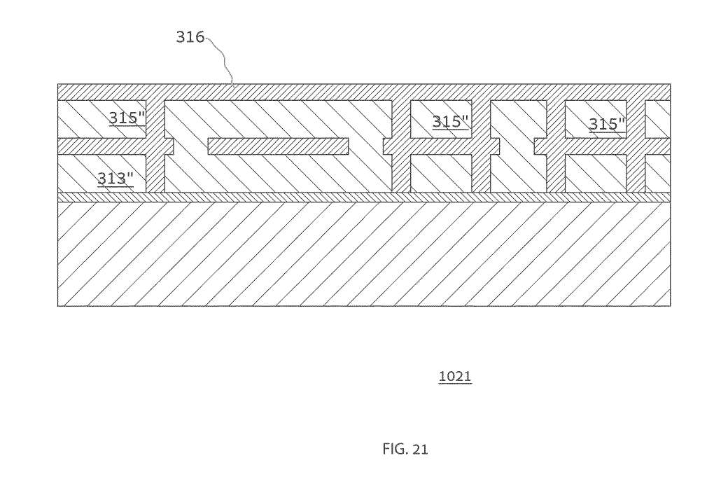

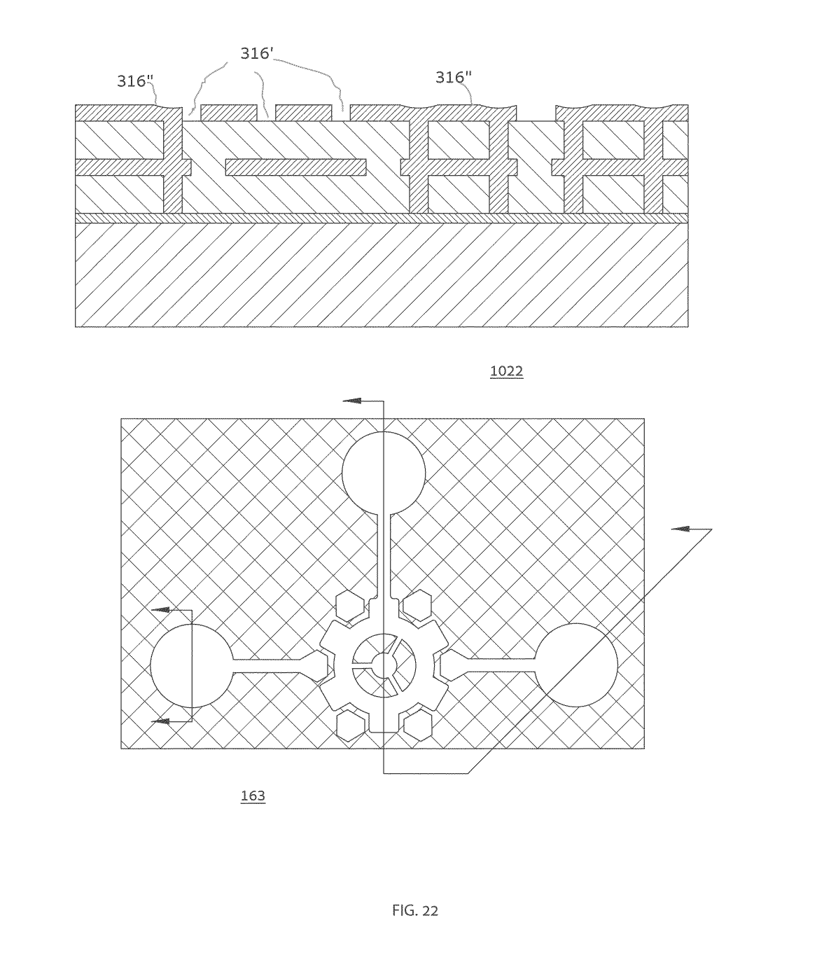

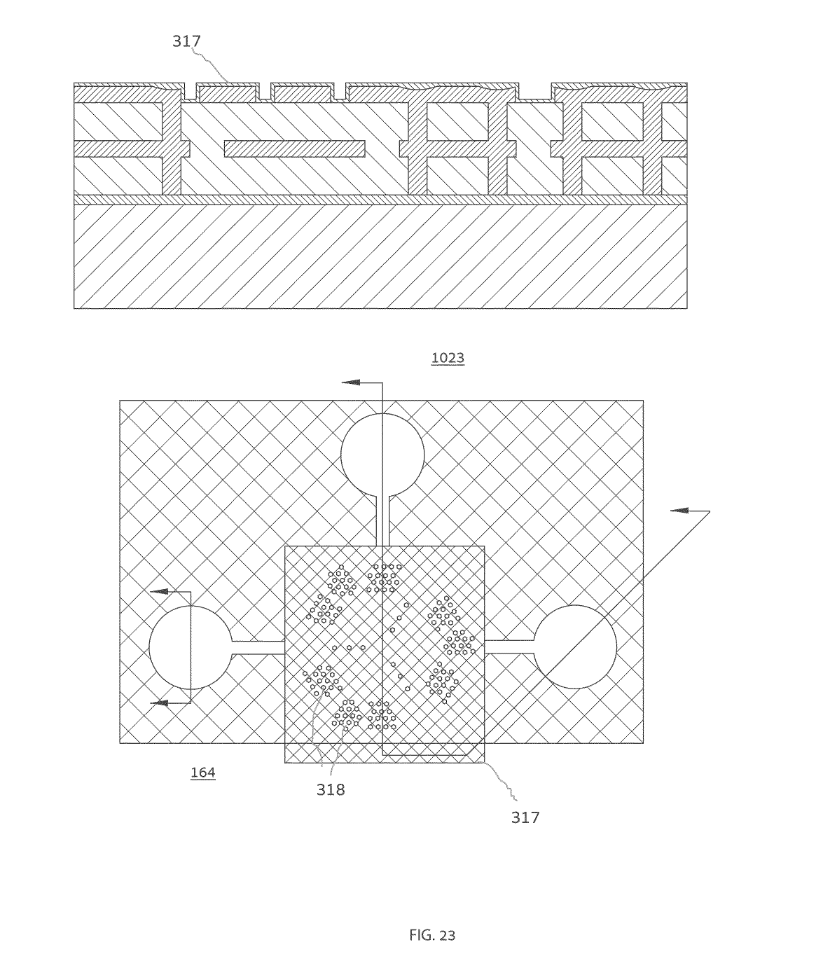

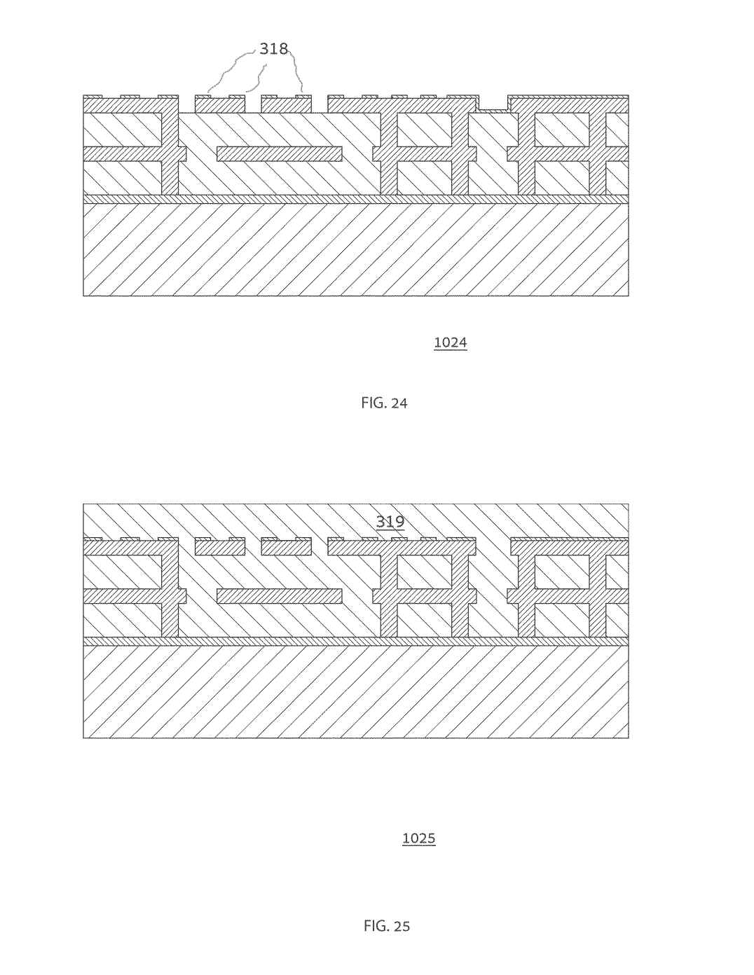

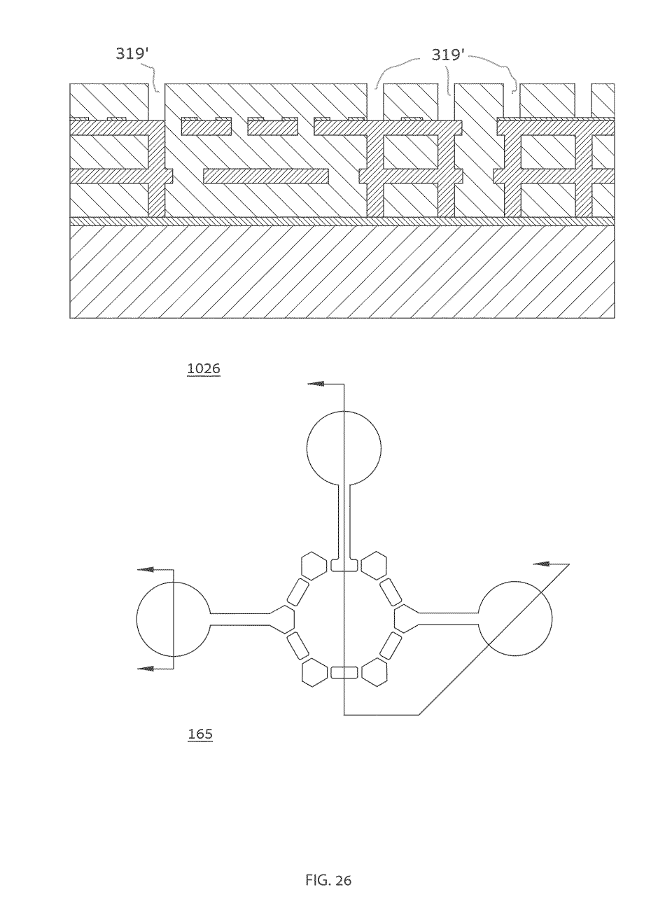

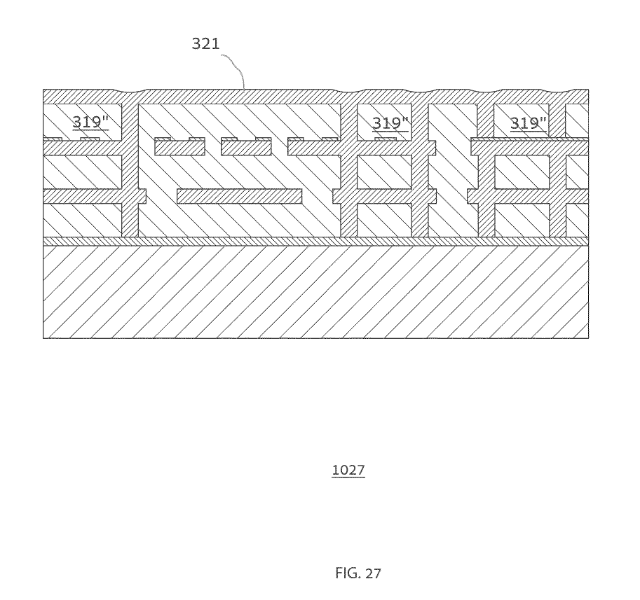

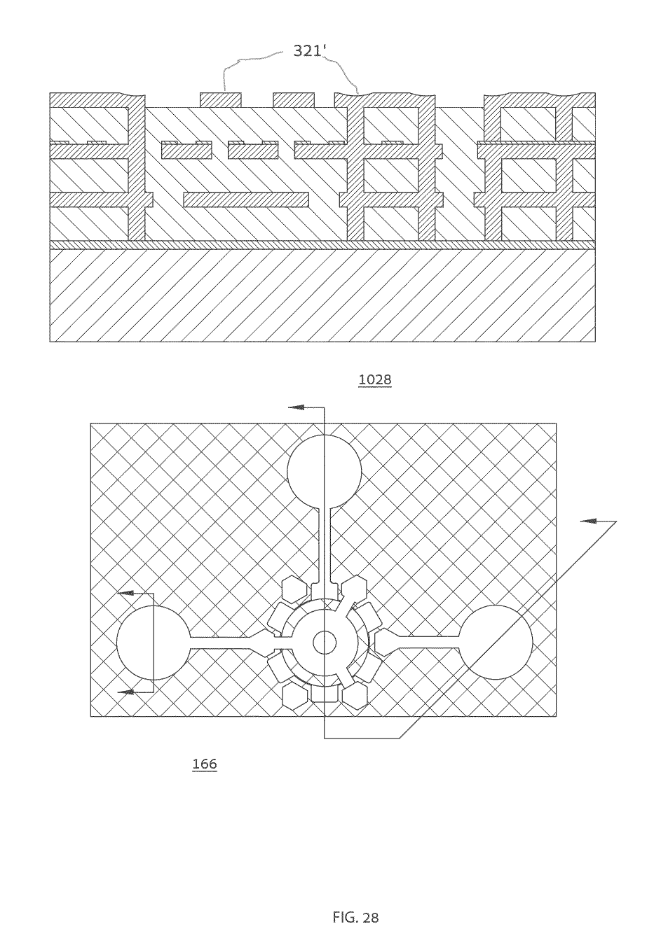

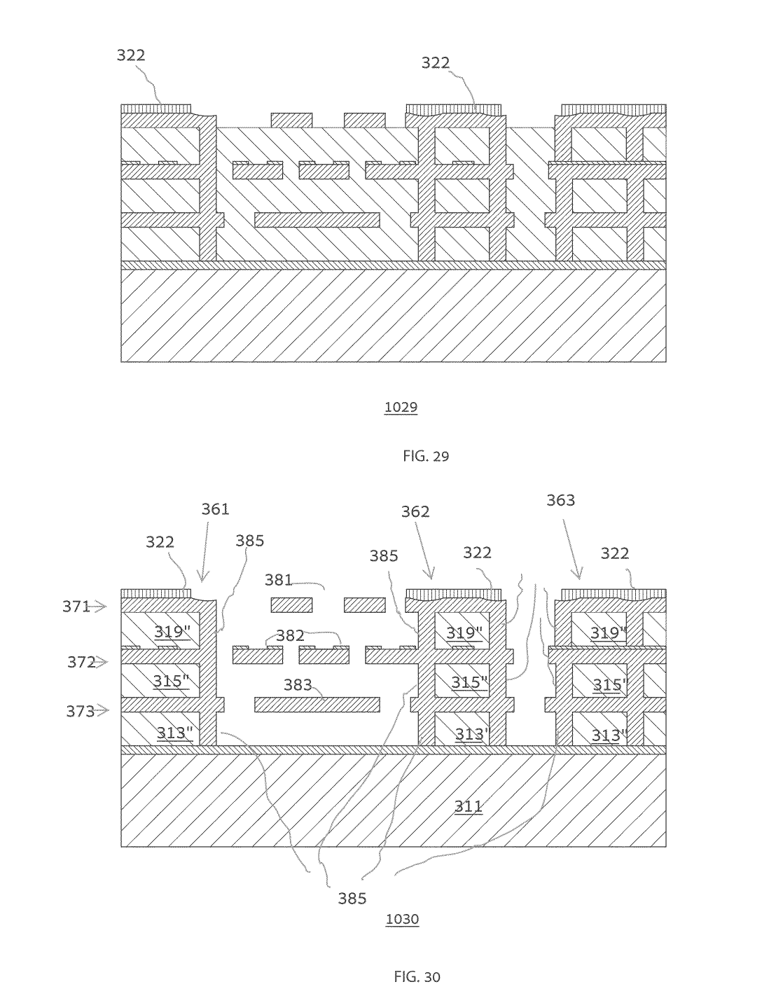

FIGS. 16-30 illustrates the following manufacturing steps:
a. Cross section 1015 of FIG. 16 illustrates a substrate 311, intermediate layer 312 and sacrificial layer 313. Cross section 1016 of FIG. 16 illustrates using (step 1410, step 1510) a first mask to pattern release barriers. The pattern is formed (see holes 313′) in a sacrificial layer that may be made of Tetraethyl orthosilicate (TEOS), Silicon Oxide, and undoped Silica glass (USG). The pattern may include one or more core elements such as 313″. FIG. 16 includes a top view and an arrow that indicates where the cross section of FIG. 16 was taken.
b. Cross section 1017 of FIG. 17 illustrates Poly deposition—to form a conductive layer 314 that fills the pattern release barriers (intermediate layer below membrane layer).
a. Cross section 1018 of FIG. 18 illustrates using (step 1420) a second mask to pattern membrane layer. Conductive layer pattern is denoted 314′. FIG. 18 includes a top view and an arrow that indicates where the cross section of FIG. 18 was taken. The cross section was taken along a membrane and two pillars.
b. Cross section 1019 of FIG. 19 illustrates depositing TEOS/USG layer (sacrificial layer 315—which is the intermediate layer between membrane and blind layers.
c. Cross section 1020 of FIG. 20 illustrates using a third mask to form a perforated layer barrier. FIG. 20 illustrates holes 315′ formed in the sacrificial layer 315. Regions denoted 315″ will become core elements in FIG. 21.
d. Cross section 1021 of FIG. 21 illustrates Poly silicon deposition-Filling Pattern Release Barriers. Conductive layer 316 is deposited, fills holes 315′ and forms the core elements 315″.
e. Cross section 1022 of FIG. 22 illustrates using a fourth mask for Poly deposition of a perforated layer (blind layer). Conductive layer patterns are denoted 316′. FIG. 22 includes a top view and an arrow that indicates where the cross section of FIG. 22 was taken—along three pillars and along the blind.
f. Cross section 1023 of FIG. 23 illustrates depositing a dielectric layer 317 on the perforated layer (blind layer), also for acoustic isolation. The top view 164 of FIG. 23 illustrates that the dielectric layer is deposited around the location of the blind and includes holes for dimples 318.
g. Cross section 1024 of FIG. 24 illustrates using a sixth mask for dimples & perforated isolation etch. Dimples 318 are formed.
h. Cross section 1025 of FIG. 25 illustrates depositing a sacrificial layer 319 such as another TEOS/USG layer (intermediate layer between dielectric layer and shutter layer).
i. Cross section 1026 of FIG. 26 illustrates using a seventh mask for hole contacts and barriers. Holes 319′ are formed in sacrificial layer 319. FIG. 26 also includes top view 165.
j. Cross section 1027 of FIG. 27 illustrates Poly deposition (conductive layer 321)—Filling Pattern Release Barriers of hole and contacts+Shutter Layer deposition. The deposition of the conductive layer surrounds core elements 319″.
k. Cross section 1028 of FIG. 28 illustrates using an eighth mask for shutter layer. Conductive layer 321 is patterned to form patterns 321′. Top view 166 illustrates the cross section taken through three pillars and the shutter.
l. Cross section 1029 of FIG. 29 illustrates using (step 1430) a ninth mask for contacts deposition (for example—a contact per pillar). Contacts 322 are formed.
m. Cross section 1030 of FIG. 30 illustrates release device (removing sacrificial layer patterns that are exposed to an etch process)—steps 1440 and 1520. Cross section 1030 illustrates a MEMS speaker that includes membrane 383, blind 382 and shutter 381. The MEMS speaker is surrounded by spaced apart pillars (supporting structures) 361, 362 and 363. The structural elements include an electrically conductive envelope 385. Each structural element includes core elements 313″, 315″ and 319″ that are surrounded by conductive elements. Cross section 1030 illustrates three functional layers 373, 372 and 371 that are spaced apart from each other.

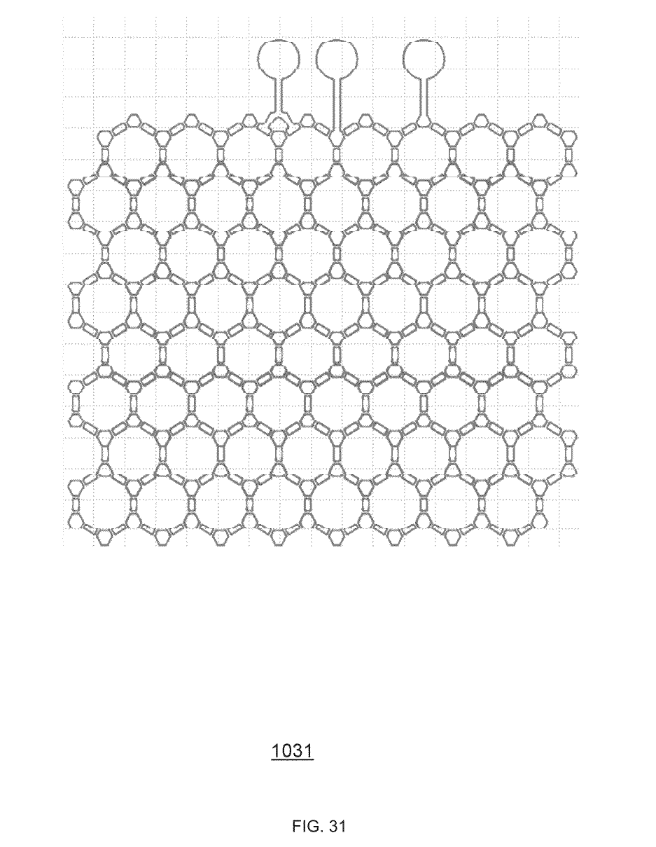

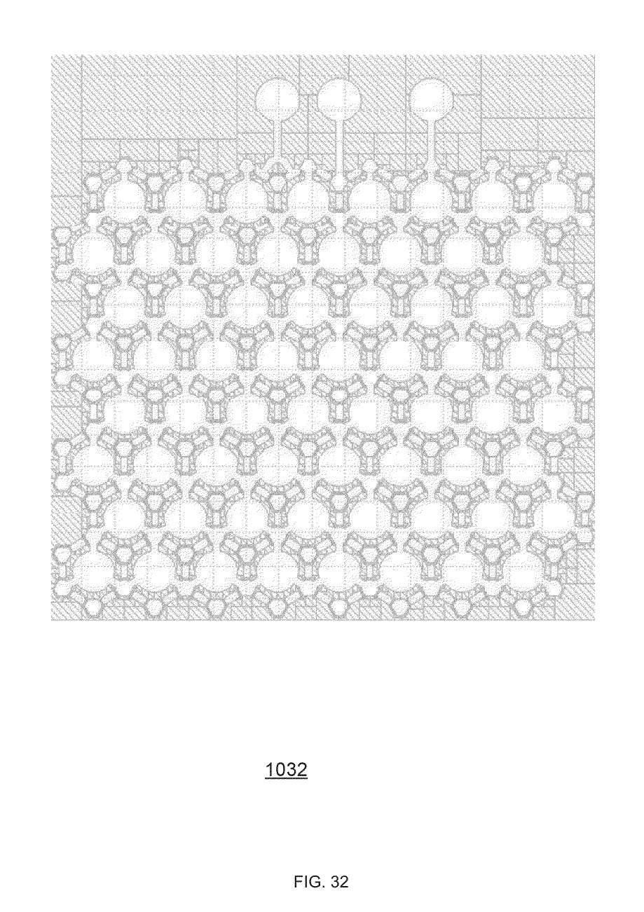

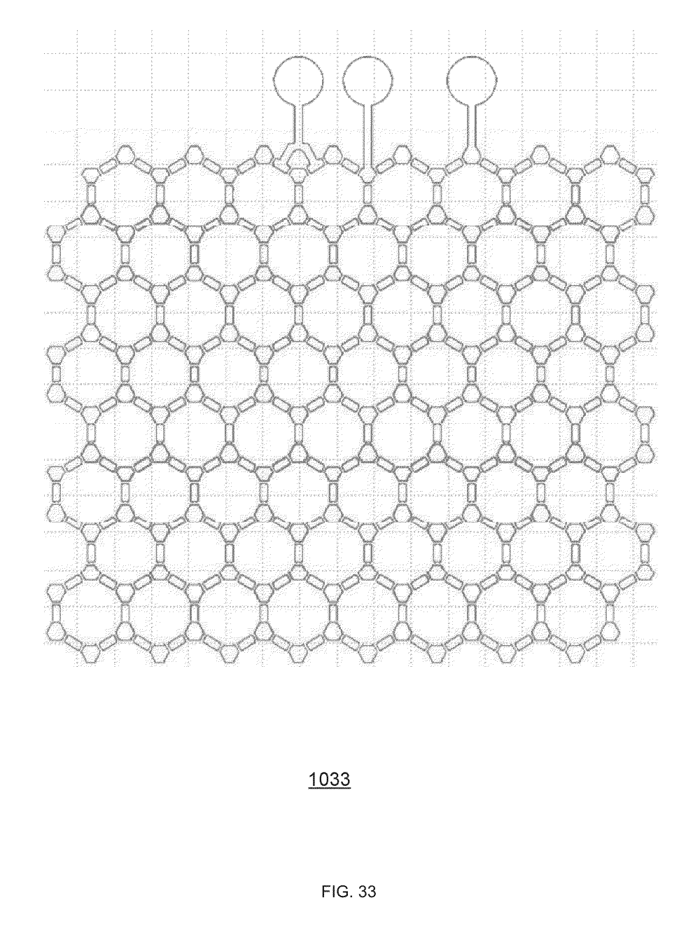

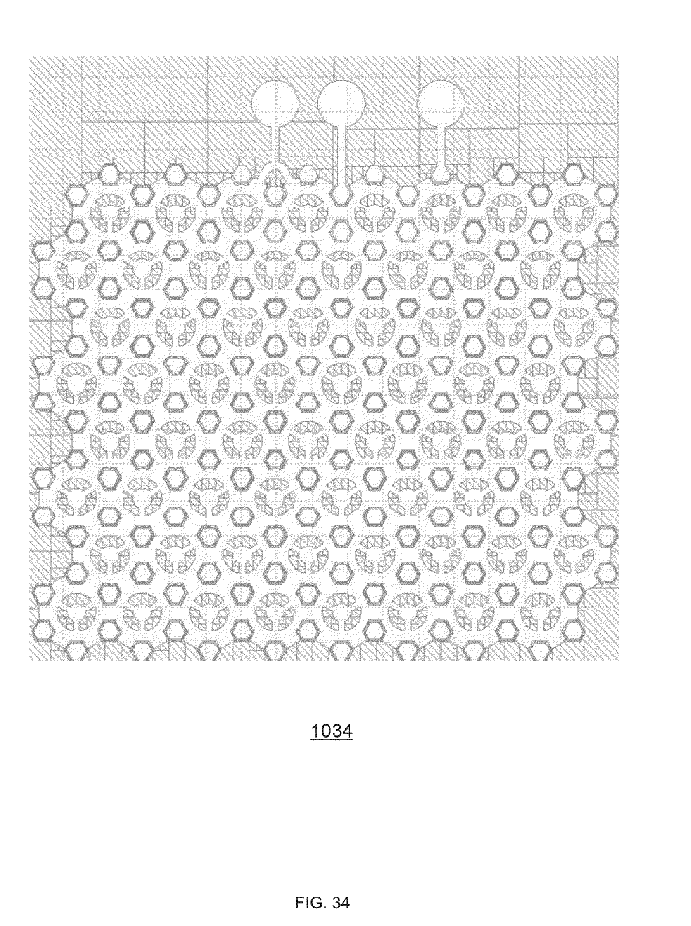

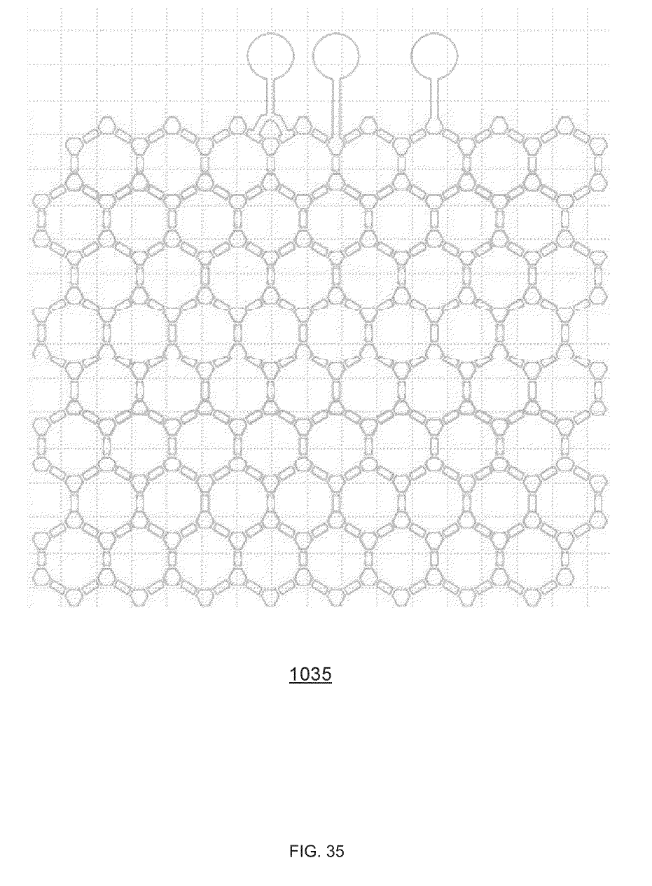

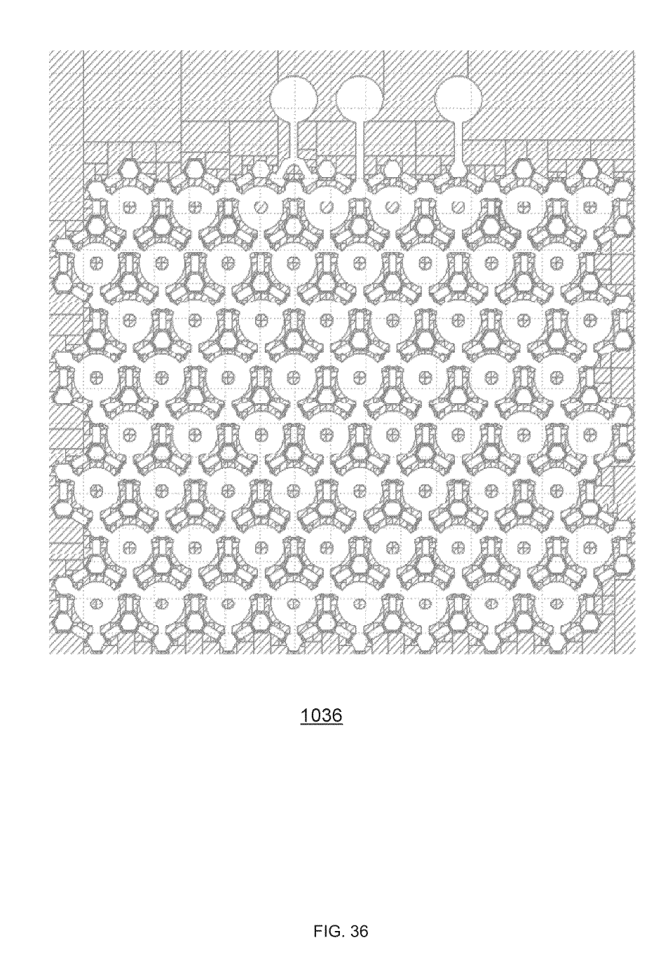

FIGS. 31-36 include top views and cross sectional views of a MEMS device during different manufacturing steps according to an another embodiment of the invention.

FIGS. 31-36 illustrate the following masks, all masks are used to form an array of eight by eight functional elements, each functional element is surrounded by a group of support structure (pillars):
a. A first mask 1031—pattern release mask—defines the edges of second portions of support structures that are positioned below the membrane layer.
b. A second mask 1032—membrane layer—defines membranes and first portions of the support structures of the membrane layer.
c. A third mask 1033—perforated layer barrier—defines the edges of second portions of support structures that are positioned between the membrane layer and the blind layer (perforated layer);
d. A fourth mask 1034—perforated layer—defines blinds and first portions of the support structures of the perforated layer.
e. A seventh mask 1035—perforated layer contacts and etch barriers—defines the edges of second portions of support structures that are positioned between the perforated layer and the shutter layer.
f. An eighth mask 1036—shutter layer—defines shutters and first portions of the support structures of the shutter layer.

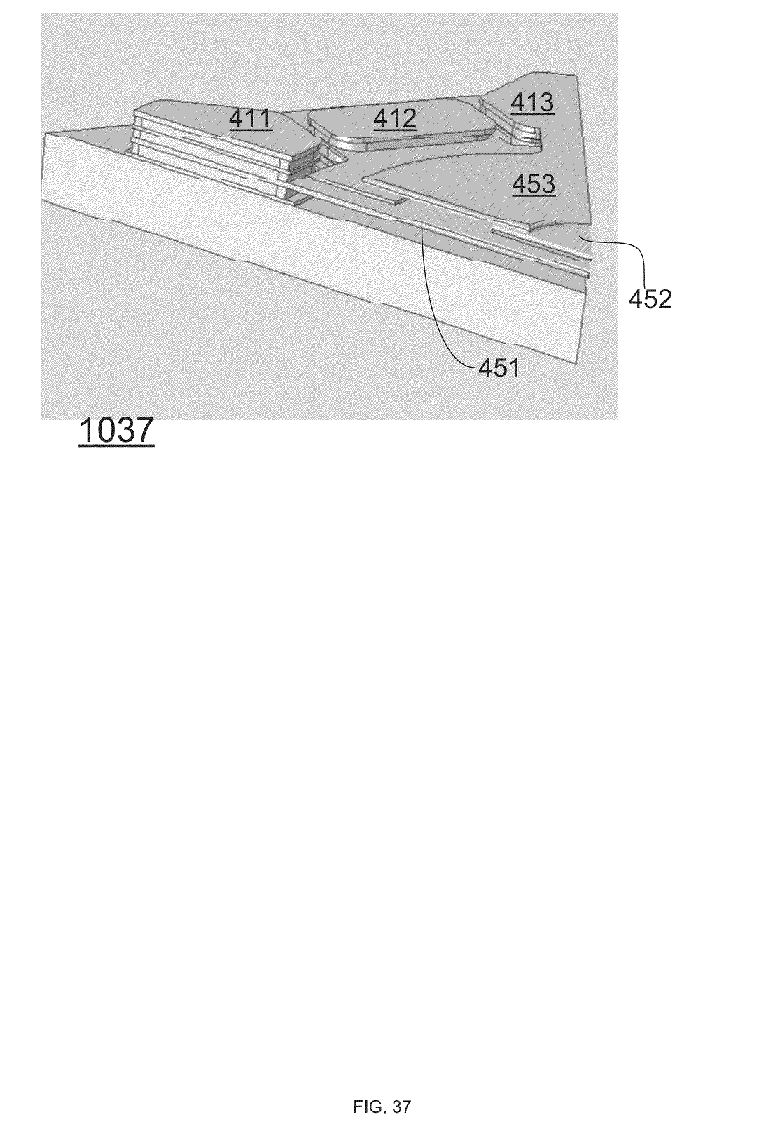

FIG. 37 is a cross sectional view of a portion 1037 of a MEMS device. This cross section illustrates support structures 411, 412 and 413, and portions of membrane 451, blind 452 and shutter 453.

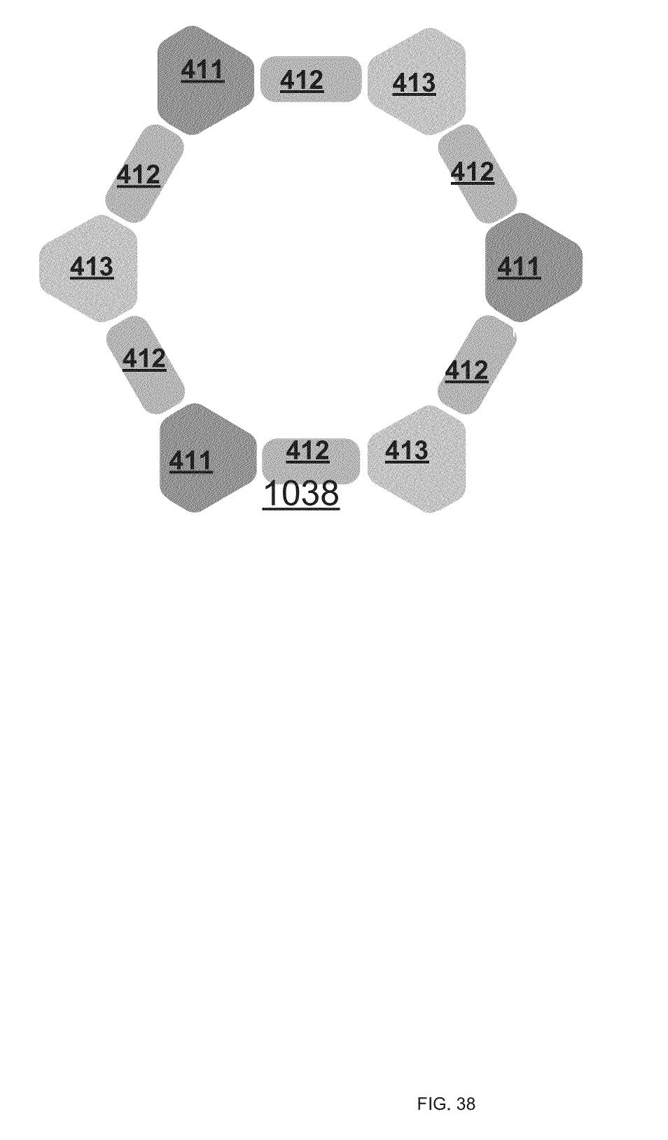

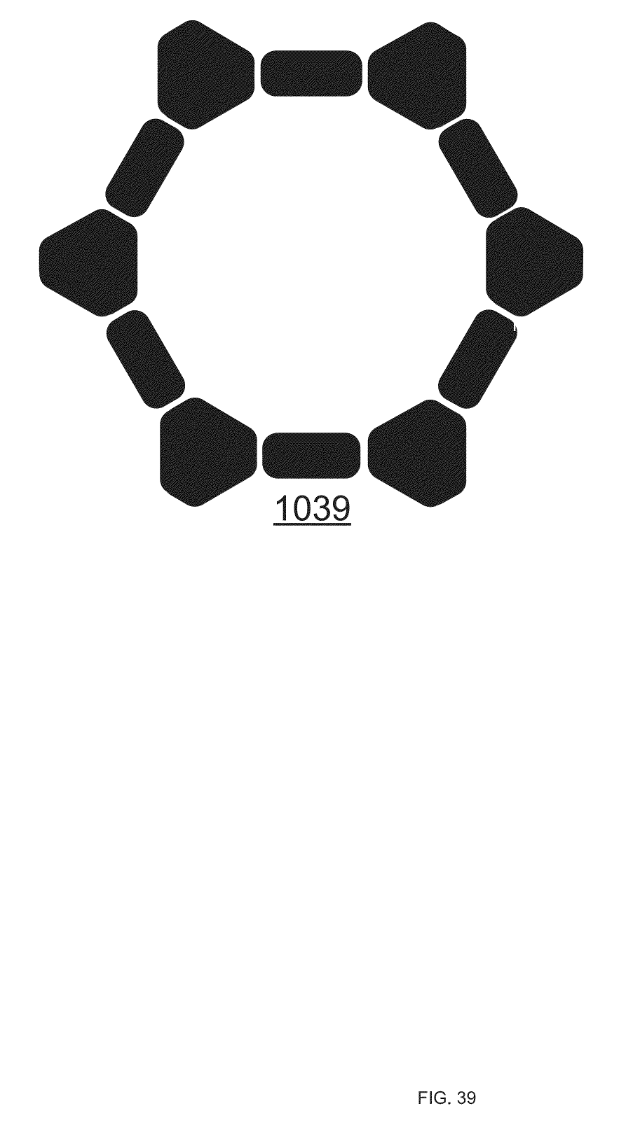

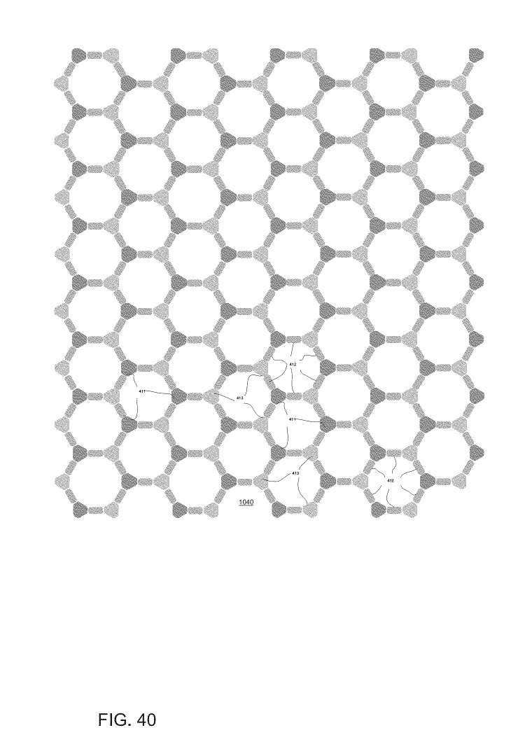

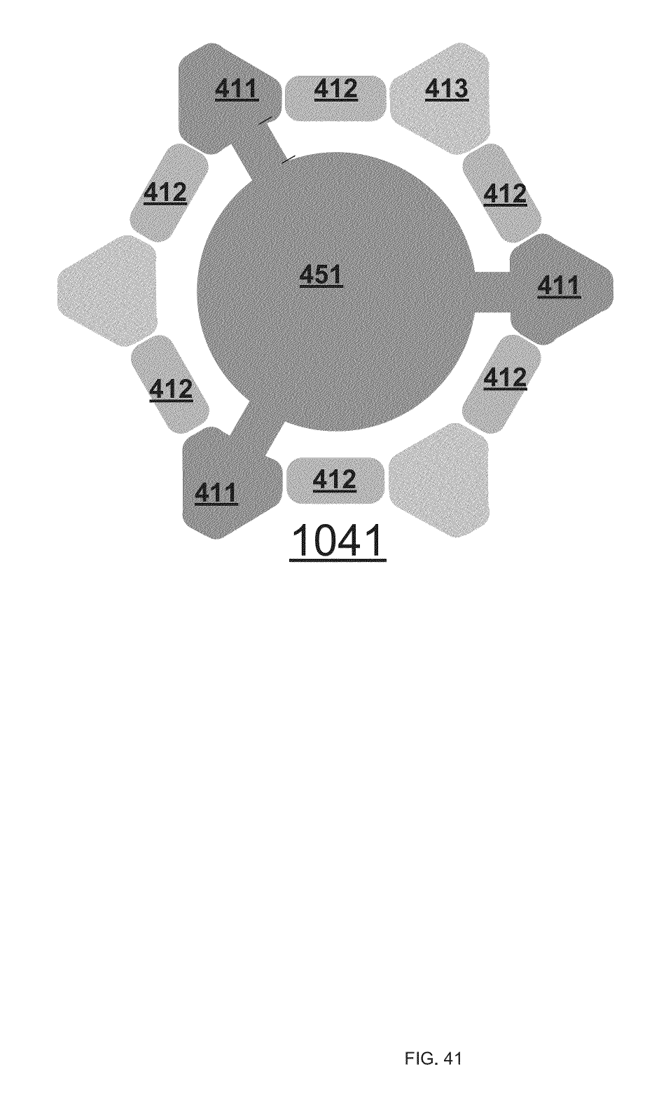

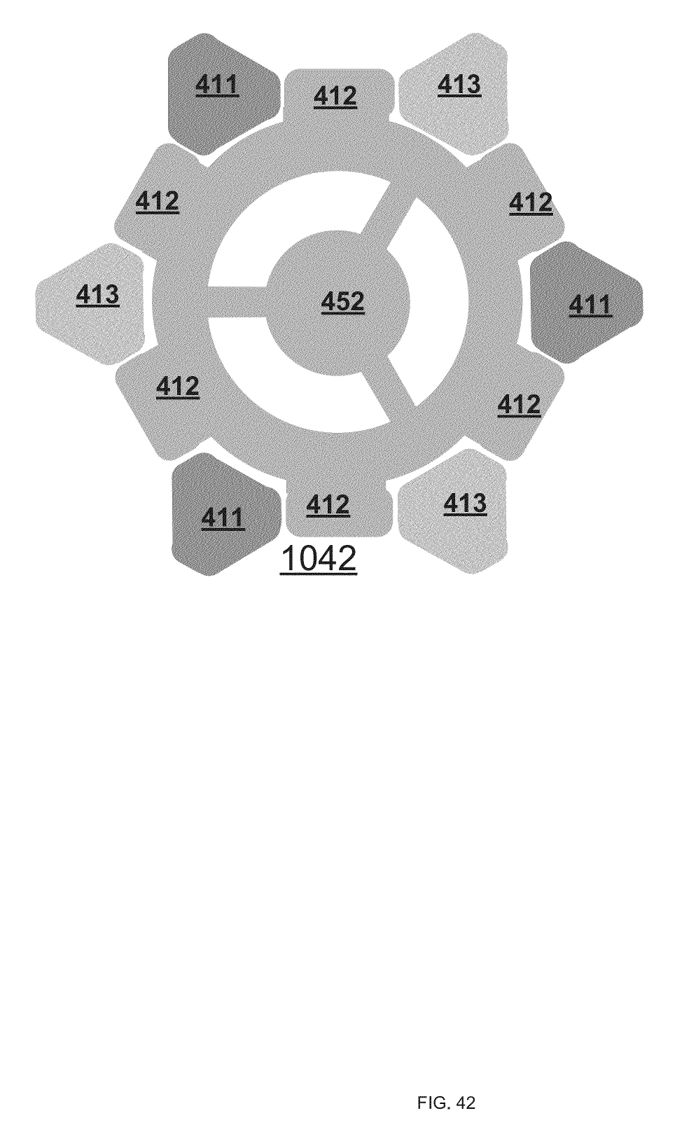

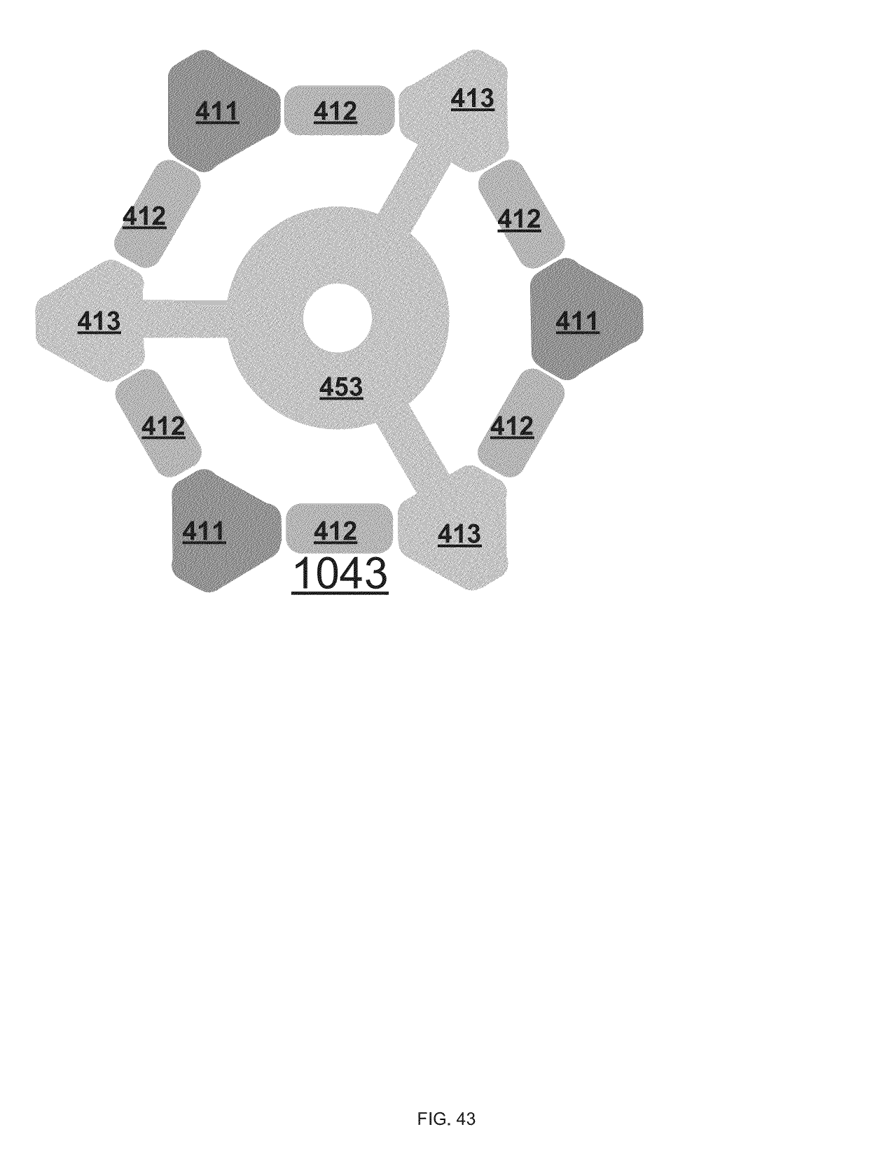

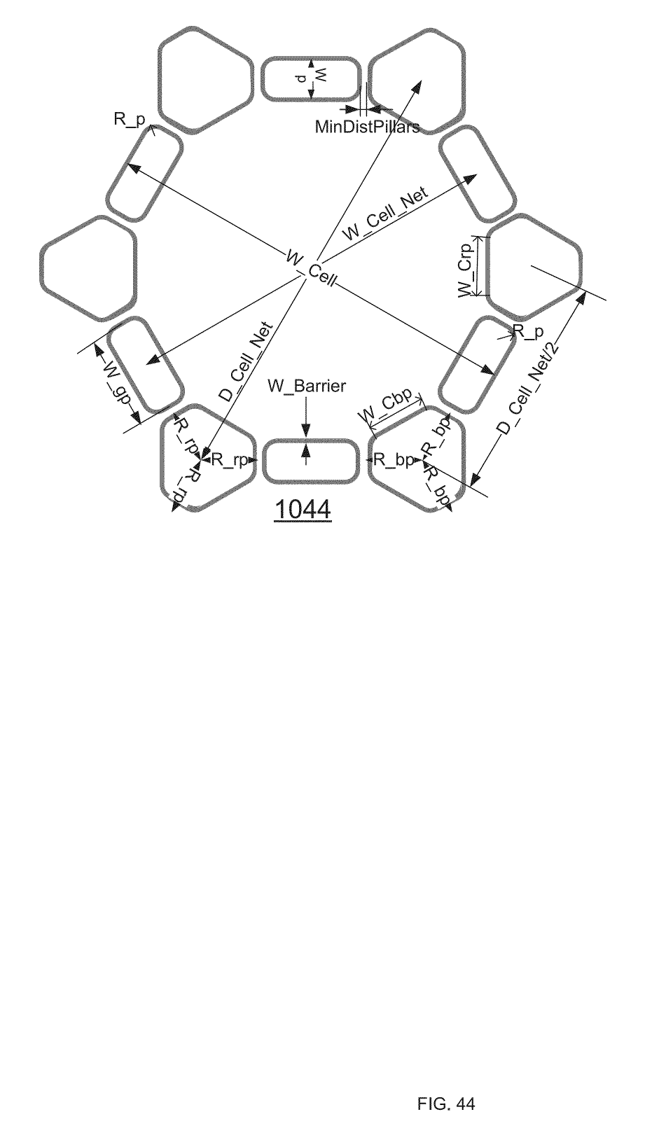

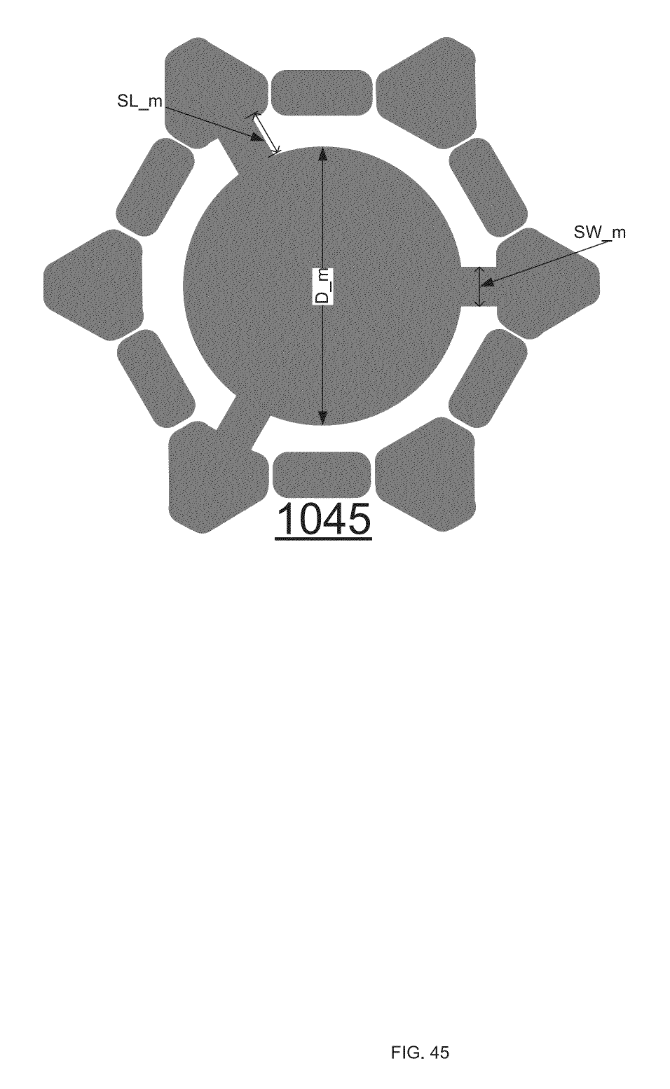

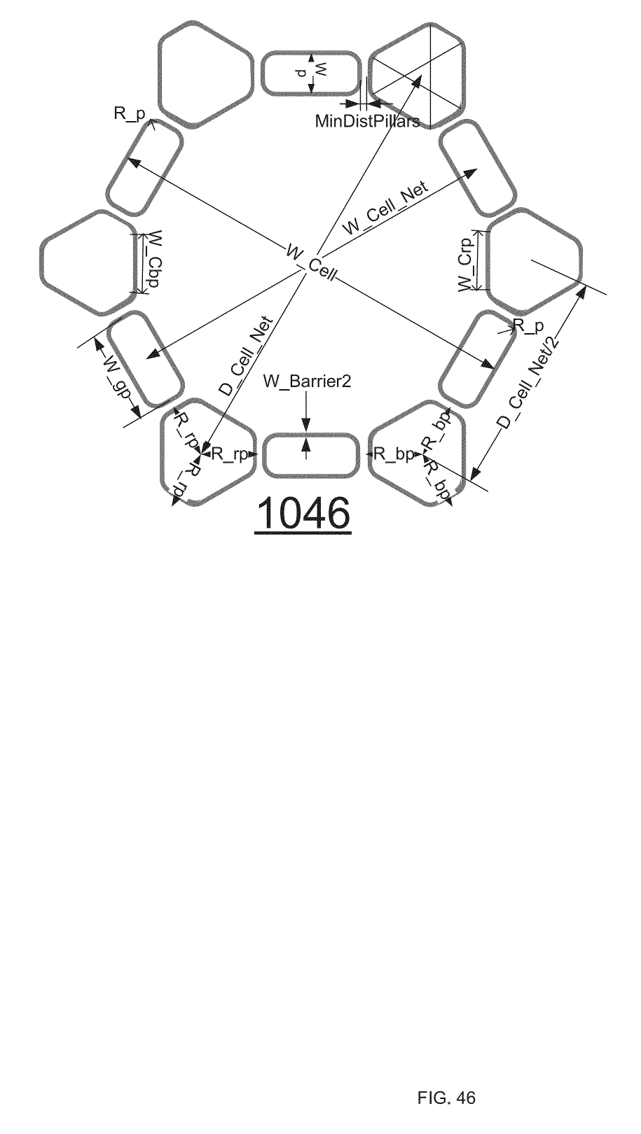

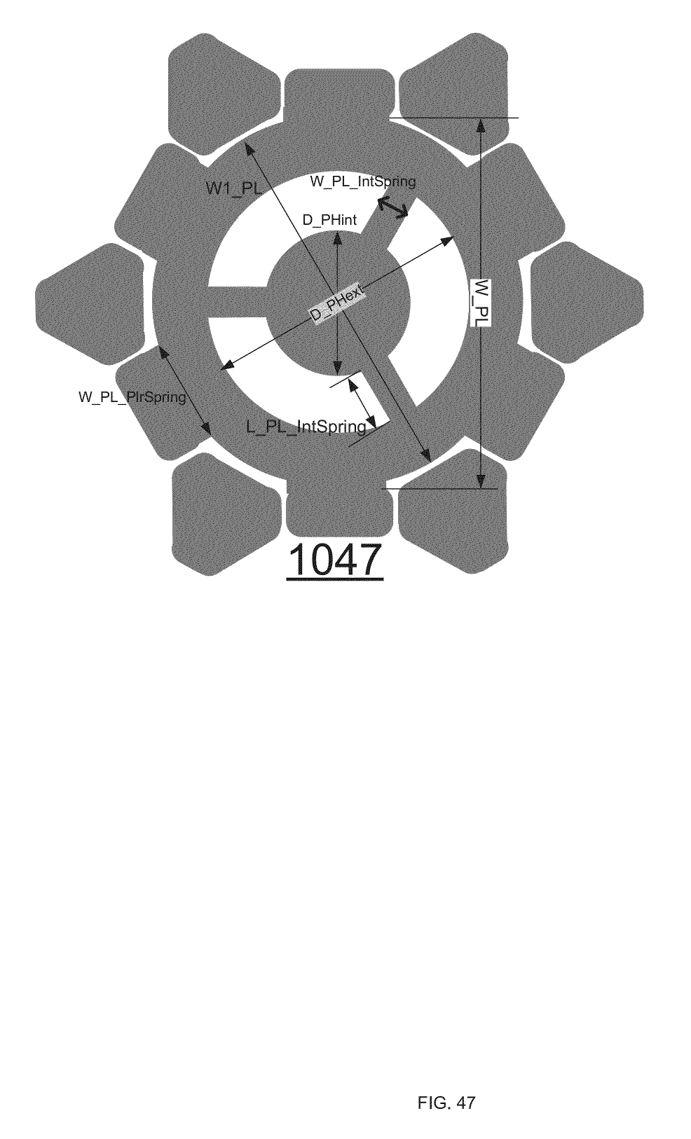

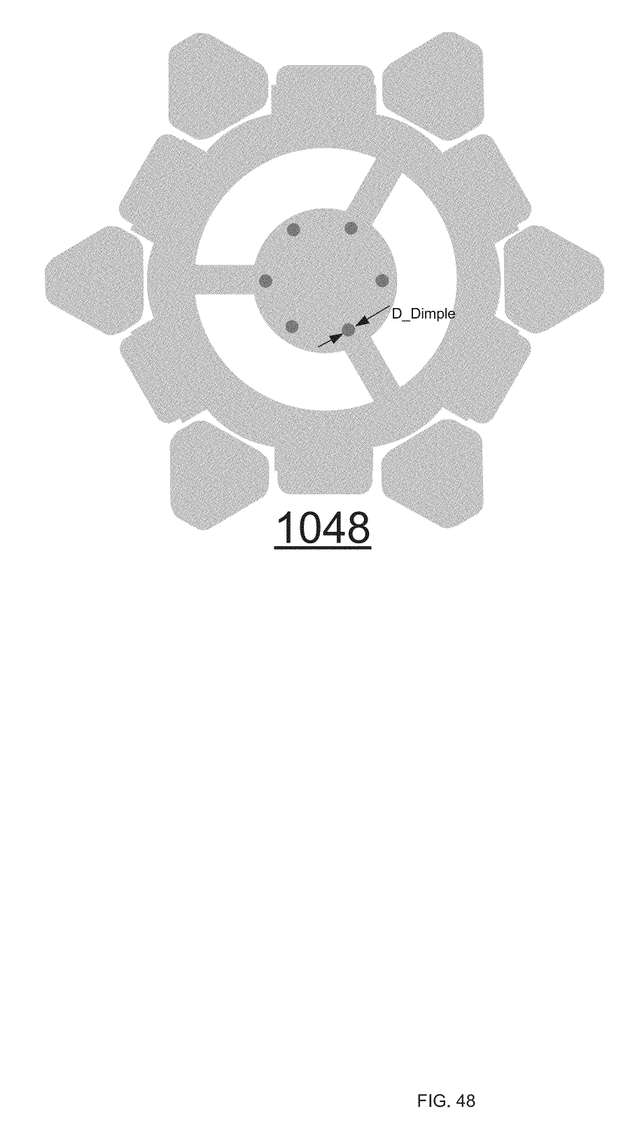

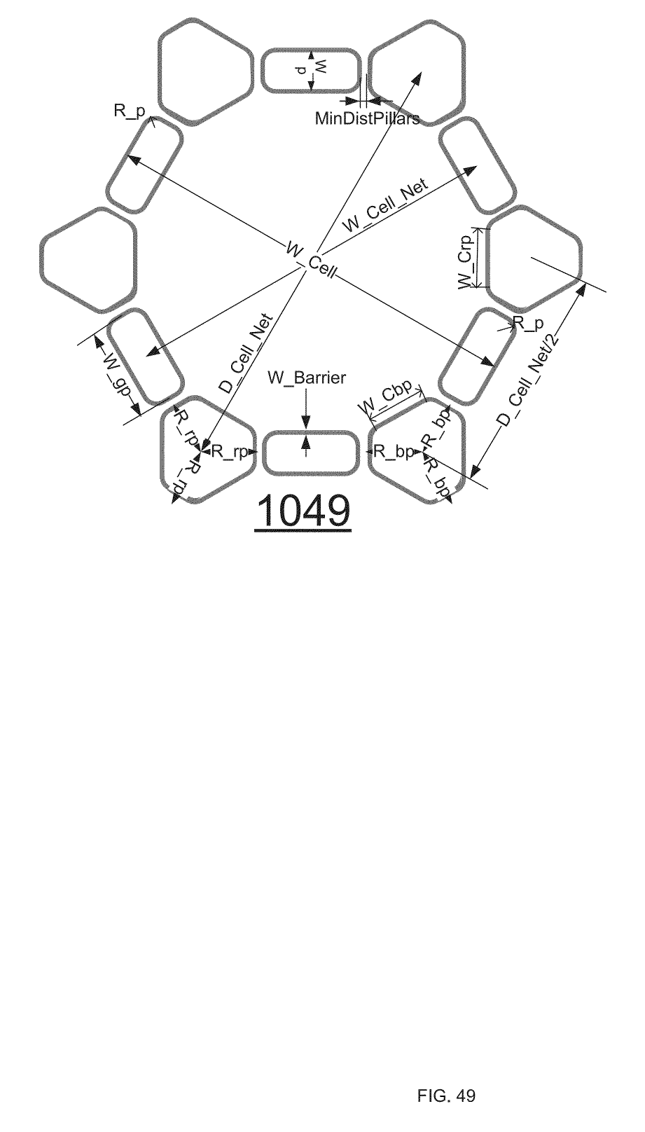

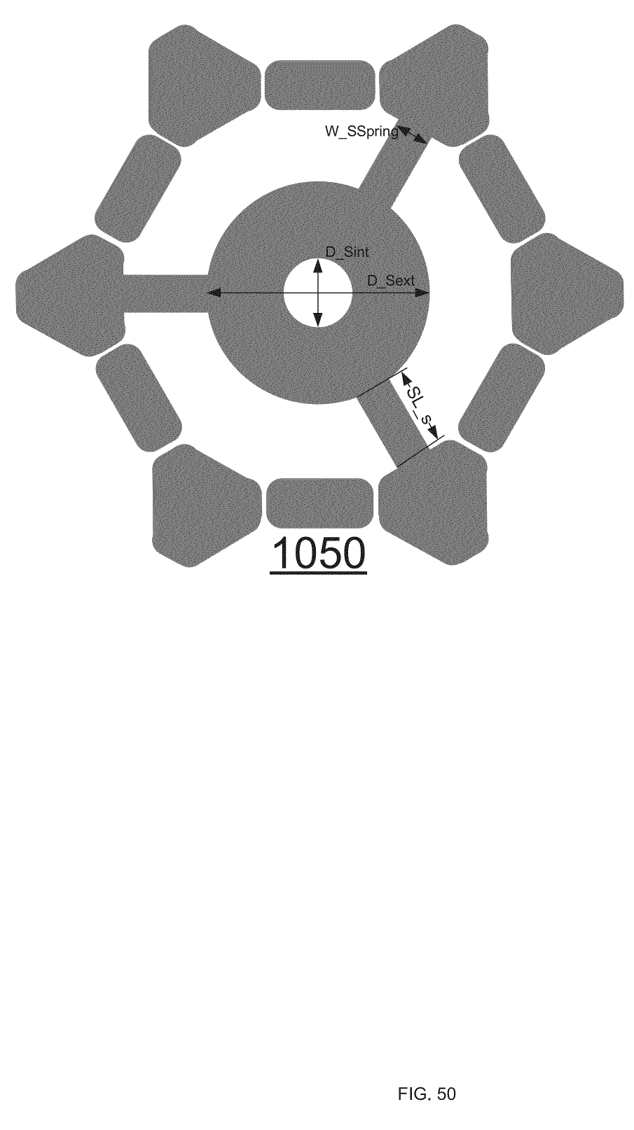

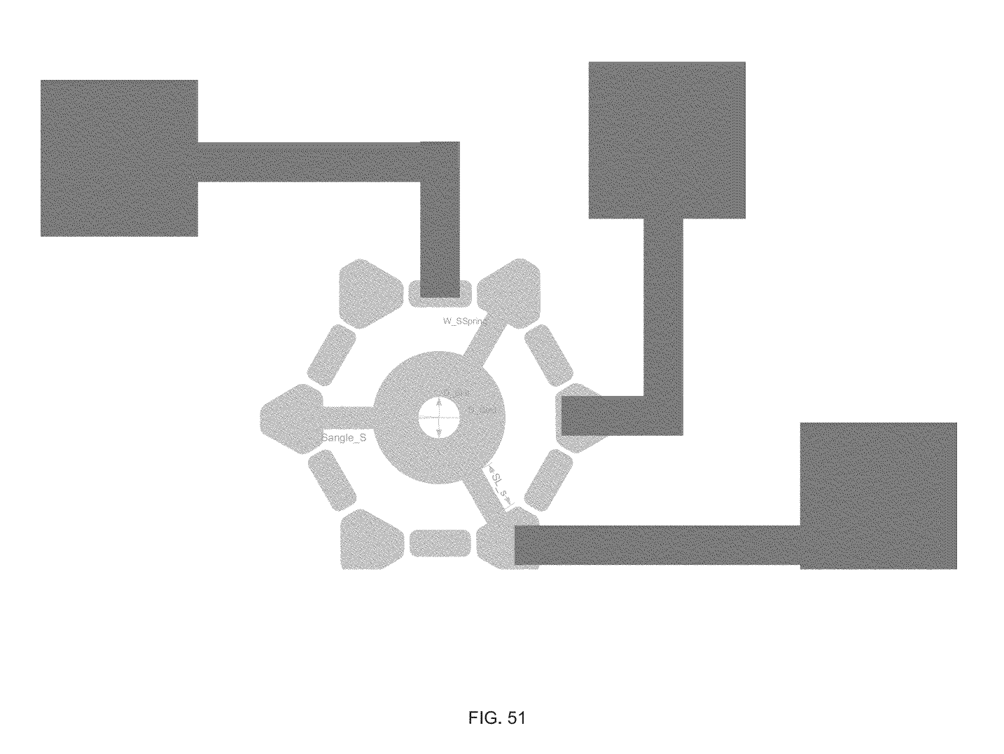

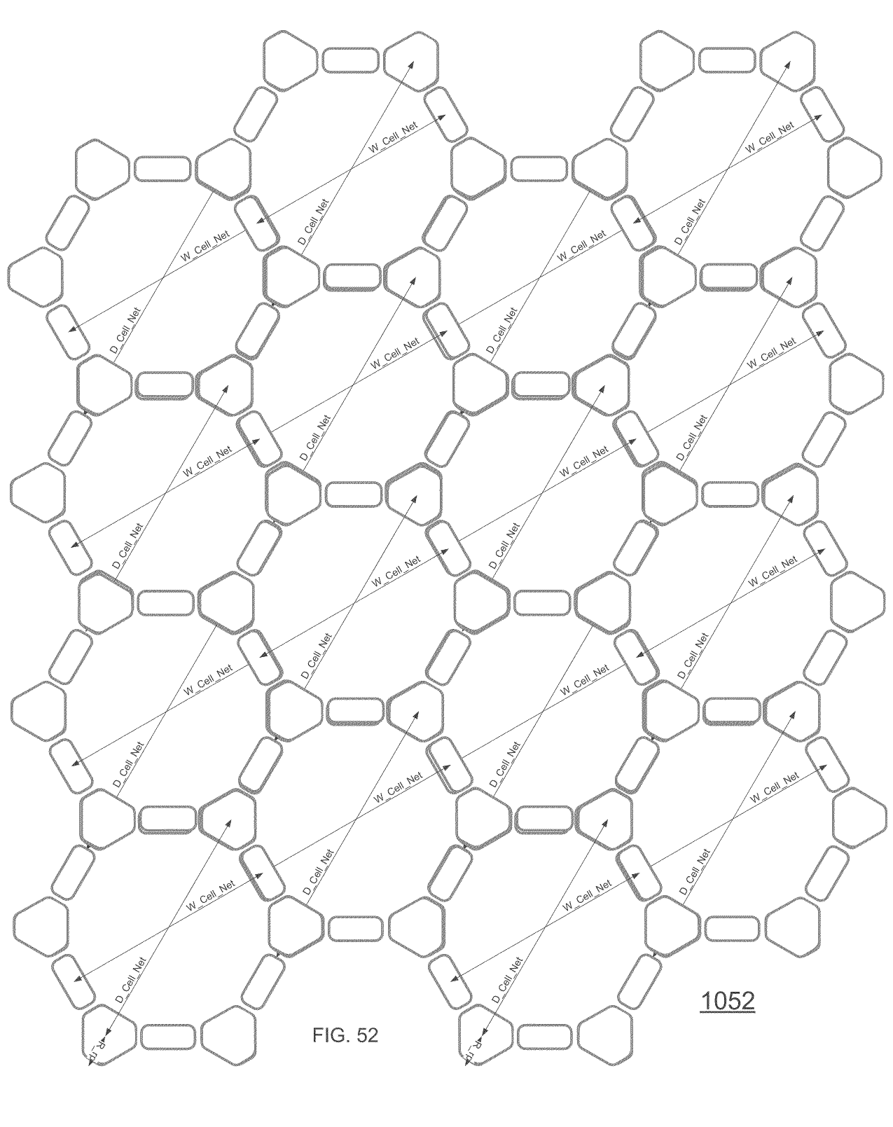

FIGS. 38-52 illustrate masks and a cross sectional view of a MEMS device according to an embodiment of the invention, with a single cell in hexagonal shape:
a. FIG. 38 illustrates a set 1038 of support structure of a single cell of an array comprising the MEMS device according to an embodiment of the invention.
b. FIG. 39 illustrates a set 1039 of support structure of a single cell of an array comprising the MEMS device according to an embodiment of the invention.
c. FIG. 40 illustrates an array 1040 of support structures 411, 412 and 413 of multiple MEMS cells according to an embodiment of the invention.
d. FIG. 41 illustrates a first layer 1041 that includes membrane 451 and a set of support structures 411, 412 and 413 according to an embodiment of the invention. Support structures 411 are electrically coupled to membrane 451 while support structures 412 and 413 are not electrically coupled to membrane 451.
e. FIG. 42 illustrates a second layer 1042 that includes a blind 452 and a set of support structures 411, 412 and 413 according to an embodiment of the invention. Support structures 412 are electrically coupled to blind 452 while support structures 411 and 413 are not electrically coupled to blind 452.
f. FIG. 43 illustrates a third layer 1043 that includes shutter 453 and a set of support structures 411, 412 and 413 according to an embodiment of the invention. Support structures 413 are electrically coupled to shutter 453 while support structures 411 and 412 are not electrically coupled to shutter 453.
g. FIG. 44 illustrates a mask 1044 for pattern release barriers according to an embodiment of the invention.
h. FIG. 45 illustrates a mask 1045 for patterning a membrane layer according to an embodiment of the invention.
i. FIG. 46 illustrates a mask 1046 for patterning a contact to membrane layer according to an embodiment of the invention.
j. FIG. 47 illustrates a mask 1047 for patterning a blind layer according to an embodiment of the invention.
k. FIG. 48 illustrates a mask 1048 for “dimples” according to an embodiment of the invention.
l. FIG. 49 illustrates a mask 1049 patterning contacts to the blind layer according to an embodiment of the invention.
m. FIG. 50 illustrates a mask 1050 for patterning a shutter layer according to an embodiment of the invention.
n. FIG. 51 illustrates a mask 1051 for bond pad patterning and etch according to an embodiment of the invention.
o. FIG. 52 illustrates a mask 1052 for pattern release barriers of an array of set of support structures of multiple MEMS cells according to an embodiment of the invention.

Any reference in the specification to a system should be applied mutatis mutandis to a method that may be executed by the system.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between MEMS cells or functional elements blocks are merely illustrative and that alternative embodiments may merge MEMS cells or functional elements or impose an alternate decomposition of functionality upon various MEMS cells or functional elements. Thus, it is to be understood that the architectures depicted herein are merely exemplary, and that in fact many other architectures may be implemented which achieve the same functionality. Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single MEMS device or within multiple MEMS devices. Alternatively, the examples may be implemented as any number of separate MEMS devices or separate MEMS devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A micro-electromechanical system (MEMS) device that comprises a substrate, support structures and functional elements;
wherein the functional elements are included in a plurality of functional layers, the plurality of functional layers are spaced apart from each other;
wherein the support structures are conductive and are configured to provide structural support to the plurality of functional layers;
wherein each functional element is electrically coupled to at least one of the support structures; and
wherein the support structures are spaced apart from each other.

2. The MEMS device according to claim 1 wherein a given support structure comprises first portions that are included within the plurality of functional layers and second portions which are positioned between the plurality of functional layers.

3. The MEMS device according to claim 2 wherein the first portions and the second portions are vertically aligned.

4. The MEMS device according to claim 2 wherein the first portions and the second portions are vertically misaligned.

5. The MEMS device according to claim 1 wherein the support structures comprise a conductive envelope and one or more core segments that are at least partially insulating.

6. The MEMS device according to claim 5 wherein the one or more core segments are made of Silicon Oxide.

7. The MEMS device according to claim 1 wherein the support structures comprise one or more core segments that are surrounded by other segments; wherein the other segments comprise a conductive envelope; wherein for a given etch process the one or more core segments exhibit an etch rate that exceeds an etch rate of the other segments.

8. The MEMS device according to claim 7 wherein the one or more core segments are made of a material selected out of Tetraethyl orthosilicate, Silicon Oxide, and undoped Silica glass (USG).

9. The MEMS device according to claim 1 wherein a number of functional layers of the plurality of functional layers exceeds three.

10. The MEMS device according to claim 1 wherein the MEMS functional elements comprise a membrane, a blind and a shutter.

11. The MEMS device according to claim 10 wherein the membrane, the blind and the shutter belong to different functional layers of the plurality of functional layers.

12. The MEMS device according to claim 1 wherein the support structures are arranged in groups.

13. The MEMS device according to claim 12 wherein a given group of support structures is electrically coupled to a given MEMS functional element; and wherein the given group of support structures surrounds the given MEMS functional element.

14. The MEMS device according to claim 12 wherein at least two groups of support structures share at least one support structure.

15. The MEMS device according to claim 12 wherein at least two adjacent groups of support structures do not share any support structure.

16. The MEMS device according to claim 12 wherein all support structures of a given group of support structures have a same size and shape.

17. The MEMS device according to claim 12 wherein two or more support structures of a given group of support structures differ from each other by shape.

18. The MEMS device according to claim 12 wherein two or more support structures of a given group of support structures differ from each other by size.

19. The MEMS device according to claim 12 wherein there are at least three support structures per group.

20. The MEMS device according to claim 1 wherein the support structures are shaped as pillars.

21. The MEMS device according to claim 1 further comprising one or more perforated dielectric functional layers.

22. The MEMS device according to claim 1 wherein a first functional element belongs to a first functional layer and wherein a second functional element belongs to a second functional layer.

23. The MEMS device according to claim 1, wherein there is an air gap between the support structures.

24. The MEMS device according to claim 1 wherein a first functional element that belongs to a first functional layer is electrically coupled to a first set of support structures; wherein a second functional element that belongs to a second functional layer is coupled to a second set of support structures; wherein the first set of support structures differs from the second set of support structures.

25. The MEMS device according to claim 1 wherein some functional elements that belong to some functional layers are electrically coupled to different sets of support structures.

26. The MEMS device according to claim 1, wherein a certain functional layer comprises multiple functional elements.

27. The MEMS device according to claim 26, wherein all of the multiple functional elements of the certain functional layer are substantially identical to each other.

28. The MEMS device according to claim 26, wherein at least some functional elements of the multiple functional elements of the certain functional layer differ from each other.

29. The MEMS device according to claim 26, wherein all of the multiple functional elements of the certain functional layer are electrically coupled to each other.

30. The MEMS device according to claim 26, wherein some of the multiple functional elements of the certain functional layer are not electrically coupled to each other.

31. The MEMS device according to claim 1 wherein a functional element that belongs to a certain functional layer is electrically coupled to a set of the support structures; wherein there is an air gap between the functional element and support structures that are not included in the set of support structures.

32. The MEMS device according to claim 1, wherein each functional layer of at least two functional layers comprises multiple functional elements. A method for manufacturing a micro-electromechanical system (MEMS) device, the method comprises:
generating multiple sacrificial layer patterns and multiple conductive layer patterns by repeating the steps of depositing a sacrificial layer; patterning the sacrificial layer to provide a sacrificial layer pattern; depositing a conductive layer; patterning the conductive layer thereby forming a conductive layer pattern;
depositing a top sacrificial layer; patterning the top sacrificial layer to provide a top sacrificial layer pattern; depositing a top conductive layer;
depositing a metal layer;
patterning the metal layer to provide a metal layer pattern;
patterning the top conductive layer thereby forming the top conductive layer pattern; and
removing, by applying an etch process, each sacrificial layer pattern that is exposed to the etch process thereby exposing support structures and functional elements that are formed by the multiple conductive layer patterns.

33. The method according to step 33 wherein the generating of the multiple sacrificial layer patterns and of the multiple conductive layer patterns is preceded by depositing a passivation layer on a substrate; and patterning the passivation layer to provide a passivation layer pattern.

34. The method according to claim 33, wherein the multiple conductive layer patterns define the functional elements and define edges of the support structures.

35. The method according to claim 33, wherein the multiple conductive layer patterns define edges of the support structures.

36. The method according to claim 33, wherein the multiple conductive layer patterns define the functional elements.

37. The method according to claim 33 wherein the functional elements are included in a plurality of functional layers, the plurality of functional layers are spaced apart from each other; wherein the support structures are conductive and are configured to provide structural support to the plurality of functional layers; wherein each functional element is electrically coupled to at least one of the support structures; and wherein the support structures are spaced apart from each other.
